(19) United States
(12) Patent Application Publication
(10) Pub. No.: US 2026/0129656 A1
(43) Pub. Date: May 7, 2026

(54) MULTI-CELL AND MULTI-SHARED CHANNEL COMMUNICATIONS

(71) Applicant: QUALCOMM Incorporated, San Diego, CA (US)

(72) Inventors: Javier RODRIGUEZ FERNANDEZ, San Diego, CA (US); Kazuki TAKEDA, Minato-ku (JP)

(21) Appl. No.: 19/378,150

(22) Filed: Nov. 3, 2025

Related U.S. Application Data
(60) Provisional application No. 63/717,776, filed on Nov. 7, 2024.

(51) Int. Cl. H04W 72/232; H04L 5/00; H04W 72/0446

(52) U.S. Cl. CPC H04W 72/232; H04L 5/0055; H04W 72/0446

(57) ABSTRACT

Methods, systems, and devices for wireless communications are described. A user equipment (UE) receive a downlink control information (DCI) message that schedules multiple shared channel communication across multiple cells. The DCI message may include one or more fields that are applicable to the shared channel communications, and the field may have a maximum quantity of bits that is based on a maximum quantity of scheduled shared channel communications associated with the multiple cells. The UE may communicate the shared channel communications via respective cells in accordance with one or more respective bits of the field. The UE may transmit one or more feedback messages associated with the shared channel communications in accordance with an offset from a last symbol of a final communication based on the DCI that scheduled the shared channel communications across multiple cells.

### CROSS REFERENCES

The present Application for Patent claims benefit of U.S. Provisional Patent Application No. 63/717,776 by RODRIGUEZ FERNANDEZ et al., entitled “MULTI-CELL AND MULTI-SHARED CHANNEL COMMUNICATIONS,” filed Nov. 7, 2024, assigned to the assignee hereof, and expressly incorporated by reference herein.

### INTRODUCTION

The following relates to wireless communications, including managing multiple shared channel communications across multiple cells.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain, generating one or more bits for a first feedback message in accordance with a sub-codebook of a set of multiple sub-codebooks that is associated with the set of multiple downlink messages across the set of multiple cells, where the one or more bits are ordered by starting reception time among downlink messages received via the first cell, first, and by cell index of the set of multiple cells, second, and transmitting the first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the transmission of the first feedback message is based on the generation of the one or more bits.

An apparatus for wireless communication at a UE is described. The apparatus may include one or more memories, and one or more processors coupled with the one or more memories. The one or more processors may be configured to cause the UE to receive a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain, generate one or more bits for a first feedback message in accordance with a sub-codebook of a set of multiple sub-codebooks that is associated with the set of multiple downlink messages across the set of multiple cells, where the one or more bits are ordered by starting reception time among downlink messages received via the first cell, first, and by cell index of the set of multiple cells, second, and transmit the first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the transmission of the first feedback message is based on the generation of the one or more bits.

Another apparatus for wireless communication at a UE is described. The apparatus may include means for receiving a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain, means for generating one or more bits for a first feedback message in accordance with a sub-codebook of a set of multiple sub-codebooks that is associated with the set of multiple downlink messages across the set of multiple cells, where the one or more bits are ordered by starting reception time among downlink messages received via the first cell, first, and by cell index of the set of multiple cells, second, and means for transmitting the first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the transmission of the first feedback message is based on the generation of the one or more bits.

A non-transitory computer-readable medium storing code for wireless communication is described. The code may include instructions executable by one or more processors to receive a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain, generate one or more bits for a first feedback message in accordance with a sub-codebook of a set of multiple sub-codebooks that is associated with the set of multiple downlink messages across the set of multiple cells, where the one or more bits are ordered by starting reception time among downlink messages received via the first cell, first, and by cell index of the set of multiple cells, second, and transmit the first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the transmission of the first feedback message is based on the generation of the one or more bits.

In some examples of the method, apparatuses, and non-transitory computer-readable medium described herein, the first downlink message may be associated with a first processing time that terminates prior to the offset and the second downlink message may be associated with a second processing time that terminates after the offset and the method, apparatuses, and non-transitory computer-readable medium may include further operations, features, means, or instructions for transmitting, via the first feedback message, one or more acknowledgment (ACK) bits based on the first processing time and transmitting, via a second feedback message associated with the second downlink message, one or more not-acknowledgment (NACK) bits based on the second processing time.

In some examples of the method, apparatuses, and non-transitory computer-readable medium described herein, the first downlink message may be associated with a first processing time that terminates prior to the offset and the second downlink message may be associated with a second processing time that terminates after the offset, and the method, apparatuses, and non-transitory computer-readable medium may include further operations, features, means, or instructions for transmitting, via at least the first feedback message, one or more not acknowledgment (NACK) bits based on the processing time of the at least one downlink message.

Some examples of the method, apparatuses, and non-transitory computer-readable medium described herein may further include operations, features, means, or instructions for receiving a second downlink control information message that schedules a second set of multiple downlink messages that includes at least a fourth downlink message via the first cell, a fifth downlink message via the second cell, and a sixth downlink message via the first cell, where at least one downlink message of the second set of multiple downlink messages may be associated with a processing time that terminates after a second offset from a last symbol of the second set of multiple downlink messages and refraining from transmission of a feedback message associated with the fourth downlink message, the fifth downlink message, and the sixth downlink message based on the processing time of the at least one downlink message.

Some examples of the method, apparatuses, and non-transitory computer-readable medium described herein may further include operations, features, means, or instructions for generating one or more bits for the first feedback message in accordance with a set of time domain resource allocations, where the set of time domain resource allocations includes one or more entries that may be associated with each downlink message of the set of multiple downlink messages across the set of multiple cells, and where the transmission of the first feedback message may be based on the generation of the one or more bits.

Some examples of the method, apparatuses, and non-transitory computer-readable medium described herein may further include operations, features, means, or instructions for receiving, via an antenna array of the UE, a second downlink control information message within a same monitoring occasion as the downlink control information message, where the second downlink control information message schedules a second set of multiple downlink messages that includes at least a fourth downlink message via the first cell, the second cell, or a third cell and transmitting a second feedback message associated with the fourth downlink message, where the first feedback message may be transmitted prior to the second feedback message based on the downlink control information message and the second downlink control information message.

In some examples of the method, apparatuses, and non-transitory computer-readable medium described herein, the first feedback message may be transmitted prior to the second feedback message based on an order of the downlink control information message and the second downlink control information message and the order may be based on an aggregation level, a search space index, a control resource set index, a control channel element index, or any combination thereof.

In some examples of the method, apparatuses, and non-transitory computer-readable medium described herein, the first feedback message may be transmitted prior to the second feedback message based on a first reception start time of the first downlink message that occurs prior to a second reception start time of the fourth downlink message.

In some examples of the method, apparatuses, and non-transitory computer-readable medium described herein, the set of multiple downlink messages includes a fourth downlink message that may have a last symbol that occurs at a same time as the last symbol of the third downlink message in the time domain, the third downlink message may be associated with a first processing time that may be greater than a second processing time associated with the fourth downlink message, and the first feedback message may be transmitted based on the first processing time that may be greater than the second processing time.

A method for wireless communication by a UE is described. The method may include receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicating the first shared channel communication via the first cell in accordance with one or more first bits of the field associated with the first cell, communicating the second shared channel communication via the second cell in accordance with one or more second bits of the field associated with the second cell, and communicating the third shared channel communication via the first cell in accordance with one or more third bits of the field associated with the first cell.

An apparatus for wireless communication at a UE is described. The apparatus may include one or more memories, and one or more processors coupled with the one or more memories. The one or more processors may be configured to cause the UE to receive a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicate the first shared channel communication via the first cell in accordance with one or more first bits of the field associated with the first cell, communicate the second shared channel communication via the second cell in accordance with one or more second bits of the field associated with the second cell, and communicate the third shared channel communication via the first cell in accordance with one or more third bits of the field associated with the first cell.

Another apparatus for wireless communication at a UE is described. The apparatus may include means for receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, means for communicating the first shared channel communication via the first cell in accordance with one or more first bits of the field associated with the first cell, means for communicating the second shared channel communication via the second cell in accordance with one or more second bits of the field associated with the second cell, and means for communicating the third shared channel communication via the first cell in accordance with one or more third bits of the field associated with the first cell.

A non-transitory computer-readable medium storing code for wireless communication is described. The code may include instructions executable by one or more processors to receive a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicate the first shared channel communication via the first cell in accordance with one or more first bits of the field associated with the first cell, communicate the second shared channel communication via the second cell in accordance with one or more second bits of the field associated with the second cell, and communicate the third shared channel communication via the first cell in accordance with one or more third bits of the field associated with the first cell.

In some examples of the method, apparatuses, and non-transitory computer-readable medium described herein, the field includes a new data indicator field and the maximum quantity of bits may be selected for the new data indicator field based on the maximum quantity of scheduled shared channel communications.

Some examples of the method, apparatuses, and non-transitory computer-readable medium described herein may further include operations, features, means, or instructions for receiving, via an antenna array of the UE, an indication of a quantity of cells that may have scheduled shared channel communications with the UE, where an association between each bit of the field and a respective shared channel communication may be based on the quantity of cells.

In some examples of the method, apparatuses, and non-transitory computer-readable medium described herein, the field includes a redundancy version field and the method, apparatuses, and non-transitory computer-readable medium may include further operations, features, means, or instructions for receiving an indication of a quantity of bits associated with the field, where the maximum quantity of bits may be selected for the field based on the maximum quantity of scheduled shared channel communications and on the quantity of bits.

In some examples of the method, apparatuses, and non-transitory computer-readable medium described herein, the redundancy version field includes a set of multiple blocks of bits, each block of bits of the set of multiple blocks of bits may be associated with a respective shared channel communication and may have a respective quantity of bits, and the indication of the quantity of bits includes each respective quantity of bits for each shared channel communication of each cell.

Some examples of the method, apparatuses, and non-transitory computer-readable medium described herein may further include operations, features, means, or instructions for receiving, via the downlink control information message, a second field applicable to the first shared channel communication, the second shared channel communication, and the third shared channel communication, where the second field includes information associated with frequency domain resource allocation, a modulation and coding scheme, or both.

A method for wireless communication by a network entity is described. The method may include outputting a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and obtaining a first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the first feedback message includes one or more bits in accordance with a sub-codebook of a set of multiple sub-codebooks that is associated with the set of multiple downlink messages across the set of multiple cells, where the one or more bits are ordered by starting reception time among downlink messages transmitted via the first cell, first, and by cell index of the set of multiple cells, second.

An apparatus for wireless communication at a network entity is described. The apparatus may include one or more memories, and one or more processors coupled with the one or more memories. The one or more processors may be configured to cause the network entity to output a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and obtain a first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the first feedback message includes one or more bits in accordance with a sub-codebook of a set of multiple sub-codebooks that is associated with the set of multiple downlink messages across the set of multiple cells, where the one or more bits are ordered by starting reception time among downlink messages transmitted via the first cell, first, and by cell index of the set of multiple cells, second.

Another apparatus for wireless communication at a network entity is described. The network entity may include means for outputting a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and means for obtaining a first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the first feedback message includes one or more bits in accordance with a sub-codebook of a set of multiple sub-codebooks that is associated with the set of multiple downlink messages across the set of multiple cells, where the one or more bits are ordered by starting reception time among downlink messages transmitted via the first cell, first, and by cell index of the set of multiple cells, second.

A non-transitory computer-readable medium storing code for wireless communication is described. The code may include instructions executable by one or more processors to output a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and obtain a first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the first feedback message includes one or more bits in accordance with a sub-codebook of a set of multiple sub-codebooks that is associated with the set of multiple downlink messages across the set of multiple cells, where the one or more bits are ordered by starting reception time among downlink messages transmitted via the first cell, first, and by cell index of the set of multiple cells, second.

In some examples of the method, network entities, and non-transitory computer-readable medium described herein, the first downlink message may be associated with a first processing time that terminates prior to the offset and the second downlink message may be associated with a second processing time that terminates after the offset and the method, apparatuses, and non-transitory computer-readable medium may include further operations, features, means, or instructions for obtaining, via the first feedback message, one or more acknowledgment (ACK) bits based on the first processing time and obtaining, via a second feedback message associated with the second downlink message, one or more not-acknowledgment (NACK) bits based on the second processing time.

In some examples of the method, network entities, and non-transitory computer-readable medium described herein, at least one downlink message of the plurality of downlink messages may be associated with a processing time that terminates after the offset, and the method, apparatuses, and non-transitory computer-readable medium may include further operations, features, means, or instructions for obtaining, via at least the first feedback message, one or more not acknowledgment (NACK) bits based on the processing time of the at least one downlink message.

Some examples of the method, network entities, and non-transitory computer-readable medium described herein may further include operations, features, means, or instructions for outputting a second downlink control information message that schedules a second set of multiple downlink messages that includes at least a fourth downlink message via the first cell, a fifth downlink message via the second cell, and a sixth downlink message via the first cell, where at least one downlink message of the second set of multiple downlink messages may be associated with a processing time that terminates after a second offset from a last symbol of the second set of multiple downlink messages and refraining from monitoring for a feedback message associated with the fourth downlink message, the fifth downlink message, and the sixth downlink message based on the processing time of the at least one downlink message.

In some examples of the method, network entities, and non-transitory computer-readable medium described herein, the one or more bits of the first feedback message may be obtained in accordance with a set of time domain resource allocations and the set of time domain resource allocations includes one or more entries that may be associated with each downlink message of the set of multiple downlink messages across the set of multiple cells.

A method for wireless communications by a UE is described. The method may include receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicating the first shared channel communication via the first cell in accordance with one or more first bits of the field associated with the first cell, communicating the second shared channel communication via the second cell in accordance with one or more second bits of the field associated with the second cell, and communicating the third shared channel communication via the first cell in accordance with one or more third bits of the field associated with the first cell.

An apparatus for wireless communication at a UE is described. The UE may include one or more memories, and one or more processors coupled with the one or more memories. The one or more processors may be configured to cause the UE to receive a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicate the first shared channel communication via the first cell in accordance with one or more first bits of the field associated with the first cell, communicate the second shared channel communication via the second cell in accordance with one or more second bits of the field associated with the second cell, and communicate the third shared channel communication via the first cell in accordance with one or more third bits of the field associated with the first cell.

A UE for wireless communications is described. The UE may include means for receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, means for communicating the first shared channel communication via the first cell in accordance with one or more first bits of the field associated with the first cell, means for communicating the second shared channel communication via the second cell in accordance with one or more second bits of the field associated with the second cell, and means for communicating the third shared channel communication via the first cell in accordance with one or more third bits of the field associated with the first cell.

A non-transitory computer-readable medium storing code for wireless communications is described. The code may include instructions executable by one or more processors to receive a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicate the first shared channel communication via the first cell in accordance with one or more first bits of the field associated with the first cell, communicate the second shared channel communication via the second cell in accordance with one or more second bits of the field associated with the second cell, and communicate the third shared channel communication via the first cell in accordance with one or more third bits of the field associated with the first cell.

In some examples of the method, UEs, and non-transitory computer-readable medium described herein, the field includes a new data indicator field and the maximum quantity of bits may be selected for the new data indicator field based on the maximum quantity of scheduled shared channel communications.

Some examples of the method, UEs, and non-transitory computer-readable medium described herein may further include operations, features, means, or instructions for receiving an indication of a quantity of cells that may have scheduled shared channel communications with the UE, where an association between each bit of the field and a respective shared channel communication may be based on the quantity of cells.

In some examples of the method, UEs, and non-transitory computer-readable medium described herein, the field includes a redundancy version field and the method, apparatuses, and non-transitory computer-readable medium may include further operations, features, means, or instructions for receiving an indication of a quantity of bits associated with the field, where the maximum quantity of bits may be selected for the field based on the maximum quantity of scheduled shared channel communications and on the quantity of bits.

In some examples of the method, UEs, and non-transitory computer-readable medium described herein, the redundancy version field includes a set of multiple blocks of bits and each block of bits of the set of multiple blocks of bits may be associated with a respective shared channel communication and may have a respective quantity of bits corresponding to the quantity of bits.

In some examples of the method, UEs, and non-transitory computer-readable medium described herein, the redundancy version field includes a set of multiple blocks of bits, each block of bits of the set of multiple blocks of bits may be associated with a respective shared channel communication and may have a respective quantity of bits, and the indication of the quantity of bits includes each respective quantity of bits for each shared channel communication of each cell.

Some examples of the method, UEs, and non-transitory computer-readable medium described herein may further include operations, features, means, or instructions for receiving, via the downlink control information message, a second field applicable to the first shared channel communication, the second shared channel communication, and the third shared channel communication, where the second field includes information associated with frequency domain resource allocation, a modulation and coding scheme, or both.

In some examples of the method, UEs, and non-transitory computer-readable medium described herein, the second field indicates a first frequency domain resource allocation, a first modulation and coding scheme, or both for the first shared channel communication and the third shared channel communication and the second field indicates a second frequency domain resource allocation, a second modulation and coding scheme, or both for the second shared channel communication.

Some examples of the method, UEs, and non-transitory computer-readable medium described herein may further include operations, features, means, or instructions for receiving, via the downlink control information message, a second field applicable to the first shared channel communication, the second shared channel communication, and the third shared channel communication, where the second field includes information that indicates a first hybrid automatic repeat request process number for the first shared channel communication and the third shared channel communication, and indicates a second hybrid automatic repeat request process number for the second shared channel communication.

A method for wireless communications by a UE is described. The method may include receiving a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and transmitting a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

An apparatus for wireless communication at a UE is described. The UE may include one or more memories, and one or more processors coupled with the one or more memories. The one or more processors may be configured to cause the UE to receive a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and transmit a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

A UE for wireless communications is described. The UE may include means for receiving a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and means for transmitting a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

A non-transitory computer-readable medium storing code for wireless communications is described. The code may include instructions executable by one or more processors to receive a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and transmit a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

Some examples of the method, UEs, and non-transitory computer-readable medium described herein may further include operations, features, means, or instructions for generating one or more bits for the first feedback message in accordance with a set of time domain resource allocations, where the set of time domain resource allocations includes one or more entries that may be associated with each downlink message of the set of multiple downlink messages across the set of multiple cells, and where transmitting the first feedback message may be based on the generation of the one or more bits.

Some examples of the method, UEs, and non-transitory computer-readable medium described herein may further include operations, features, means, or instructions for generating one or more bits for the first feedback message in accordance with a sub-codebook of a set of multiple sub-codebooks that may be associated with the set of multiple downlink messages across the set of multiple cells, where transmitting the first feedback message may be based on the generation of the one or more bits.

Some examples of the method, UEs, and non-transitory computer-readable medium described herein may further include operations, features, means, or instructions for receiving a second downlink control information message during a same monitoring occasion as the downlink control information message, where the second downlink control information message schedules a second set of multiple downlink messages that includes at least a fourth downlink message via the first cell, the second cell, or a third cell and transmitting a second feedback message associated with the fourth downlink message, where the first feedback message may be transmitted prior to the second feedback message based on the downlink control information message and the second downlink control information message.

In some examples of the method, UEs, and non-transitory computer-readable medium described herein, the first feedback message may be transmitted prior to the second feedback message based on an order of the downlink control information message and the second downlink control information message and the order may be based on an aggregation level, a search space index, a control resource set index, a control channel element index, or any combination thereof.

In some examples of the method, UEs, and non-transitory computer-readable medium described herein, the first feedback message may be transmitted prior to the second feedback message based on a first reception start time of the first downlink message occurring prior to a second reception start time of the fourth downlink message.

Some examples of the method, UEs, and non-transitory computer-readable medium described herein may further include operations, features, means, or instructions for generating one or more bundled bits for the first feedback message, where the one or more bundled bits include feedback information associated with a first transport block of the first downlink message and at least a second transport block of the first downlink message, or associated with the first downlink message and at least a fourth downlink message different than the first downlink message, or both.

In some examples of the method, UEs, and non-transitory computer-readable medium described herein, the set of multiple downlink messages includes a fourth downlink message that may have a last symbol that occurs at a same time as the last symbol of the third downlink message in the time domain, the third downlink message may be associated with a first processing time that may be greater than a second processing time associated with the fourth downlink message, and the first feedback message may be transmitted based on the first processing time that may be greater than the second processing time.

In some examples of the method, UEs, and non-transitory computer-readable medium described herein, the first downlink message may be associated with a first processing time that terminates prior to the offset and the second downlink message may be associated with a second processing time that terminates after the offset and the method, apparatuses, and non-transitory computer-readable medium may include further operations, features, means, or instructions for transmitting, via the first feedback message, one or more acknowledgment (ACK) bits based on the first processing time and transmitting, via a second feedback message associated with the second downlink message, one or more not-acknowledgment (NACK) bits based on the second processing time.

In some examples of the method, UEs, and non-transitory computer-readable medium described herein, at least one downlink message of the plurality of downlink messages is associated with a processing time that terminates after the offset, and the method, apparatuses, and non-transitory computer-readable medium may include further operations, features, means, or instructions for transmitting, via at least the first feedback message, one or more NACK bits based on the processing time of the at least one downlink message.

Some examples of the method, UEs, and non-transitory computer-readable medium described herein may further include operations, features, means, or instructions for receiving a second downlink control information message that schedules a second set of multiple downlink messages that includes at least a fourth downlink message via the first cell, a fifth downlink message via the second cell, and a sixth downlink message via the first cell, where at least one downlink message of the second set of multiple downlink messages may be associated with a processing time that terminates after a second offset from a last symbol of the second set of multiple downlink messages and refraining from transmitting a feedback message associated with the fourth downlink message, the fifth downlink message, and the sixth downlink message based on the processing time of the at least one downlink message.

A method for wireless communications by a network entity is described. The method may include outputting a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicating the first shared channel communication via the first cell in accordance with one or more first bits of the field associated with the first cell, communicating the second shared channel communication via the second cell in accordance with one or more second bits of the field associated with the second cell, and communicating the third shared channel communication via the first cell in accordance with one or more third bits of the field associated with the first cell.

An apparatus for wireless communication at a network entity is described. The network entity may include one or more memories, and one or more processors coupled with the one or more memories. The one or more processors may be configured to cause the network entity to output a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicate the first shared channel communication via the first cell in accordance with one or more first bits of the field associated with the first cell, communicate the second shared channel communication via the second cell in accordance with one or more second bits of the field associated with the second cell, and communicate the third shared channel communication via the first cell in accordance with one or more third bits of the field associated with the first cell.

A network entity for wireless communications is described. The network entity may include means for outputting a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, means for communicating the first shared channel communication via the first cell in accordance with one or more first bits of the field associated with the first cell, means for communicating the second shared channel communication via the second cell in accordance with one or more second bits of the field associated with the second cell, and means for communicating the third shared channel communication via the first cell in accordance with one or more third bits of the field associated with the first cell.

A non-transitory computer-readable medium storing code for wireless communications is described. The code may include instructions executable by one or more processors to output a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell, communicate the first shared channel communication via the first cell in accordance with one or more first bits of the field associated with the first cell, communicate the second shared channel communication via the second cell in accordance with one or more second bits of the field associated with the second cell, and communicate the third shared channel communication via the first cell in accordance with one or more third bits of the field associated with the first cell.

In some examples of the method, network entities, and non-transitory computer-readable medium described herein, the field includes a new data indicator field and the maximum quantity of bits may be selected for the new data indicator field based on the maximum quantity of scheduled shared channel communications.

Some examples of the method, network entities, and non-transitory computer-readable medium described herein may further include operations, features, means, or instructions for outputting an indication of a quantity of cells that may have scheduled shared channel communications, where an association between each bit of the field and a respective shared channel communication may be based on the quantity of cells.

In some examples of the method, network entities, and non-transitory computer-readable medium described herein, the field includes a redundancy version field and the method, apparatuses, and non-transitory computer-readable medium may include further operations, features, means, or instructions for outputting an indication of a quantity of bits associated with the field, where the maximum quantity of bits may be selected for the field based on the maximum quantity of scheduled shared channel communications and on the quantity of bits.

In some examples of the method, network entities, and non-transitory computer-readable medium described herein, the redundancy version field includes a set of multiple blocks of bits and each block of bits of the set of multiple blocks of bits may be associated with a respective shared channel communication and may have a respective quantity of bits corresponding to the quantity of bits.

In some examples of the method, network entities, and non-transitory computer-readable medium described herein, the redundancy version field includes a set of multiple blocks of bits, each block of bits of the set of multiple blocks of bits may be associated with a respective shared channel communication and may have a respective quantity of bits, and the indication of the quantity of bits includes each respective quantity of bits for each shared channel communication of each cell.

Some examples of the method, network entities, and non-transitory computer-readable medium described herein may further include operations, features, means, or instructions for outputting, via the downlink control information message, a second field applicable to the first shared channel communication, the second shared channel communication, and the third shared channel communication, where the second field includes information associated with frequency domain resource allocation, a modulation and coding scheme, or both.

In some examples of the method, network entities, and non-transitory computer-readable medium described herein, the second field indicates a first frequency domain resource allocation, a first modulation and coding scheme, or both for the first shared channel communication and the third shared channel communication and the second field indicates a second frequency domain resource allocation, a second modulation and coding scheme, or both for the second shared channel communication.

Some examples of the method, network entities, and non-transitory computer-readable medium described herein may further include operations, features, means, or instructions for outputting, via the downlink control information message, a second field applicable to the first shared channel communication, the second shared channel communication, and the third shared channel communication, where the second field includes information that indicates a first hybrid automatic repeat request process number for the first shared channel communication and the third shared channel communication, and indicates a second hybrid automatic repeat request process number for the second shared channel communication.

A method for wireless communications by a network entity is described. The method may include outputting a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and obtaining a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

An apparatus for wireless communication at a network entity is described. The network entity may include one or more memories, and one or more processors coupled with the one or more memories. The one or more processors may be configured to cause the network entity to output a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and obtain a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

Another network entity for wireless communications is described. The network entity may include means for outputting a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and means for obtaining a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

A non-transitory computer-readable medium storing code for wireless communications is described. The code may include instructions executable by one or more processors to output a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain and obtain a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

In some examples of the method, network entities, and non-transitory computer-readable medium described herein, one or more bits of the first feedback message may be obtained in accordance with a set of time domain resource allocations and the set of time domain resource allocations includes one or more entries that may be associated with each downlink message of the set of multiple downlink messages across the set of multiple cells.

In some examples of the method, network entities, and non-transitory computer-readable medium described herein, one or more bits of the first feedback message may be obtained in accordance with a sub-codebook of a set of multiple sub-codebooks that may be associated with the set of multiple downlink messages across the set of multiple cells.

Some examples of the method, network entities, and non-transitory computer-readable medium described herein may further include operations, features, means, or instructions for outputting a second downlink control information message during a same monitoring occasion as the downlink control information message, where the second downlink control information message schedules a second set of multiple downlink messages that includes at least a fourth downlink message via the first cell, the second cell, or a third cell and obtaining a second feedback message associated with the fourth downlink message, where the first feedback message may be obtained prior to the second feedback message based on the downlink control information message and the second downlink control information message.

In some examples of the method, network entities, and non-transitory computer-readable medium described herein, the first feedback message may be obtained prior to the second feedback message based on an order of the downlink control information message and the second downlink control information message and the order may be based on an aggregation level, a search space index, a control resource set index, a control channel element index, or any combination thereof.

In some examples of the method, network entities, and non-transitory computer-readable medium described herein, the first feedback message may be transmitted prior to the second feedback message based on a first reception start time of the first downlink message occurring prior to a second reception start time of the fourth downlink message.

In some examples of the method, network entities, and non-transitory computer-readable medium described herein, the first feedback message includes one or more bundled bits that include feedback information associated with a first transport block of the first downlink message and at least a second transport block of the first downlink message, or associated with the first downlink message and at least a fourth downlink message different than the first downlink message, or both.

In some examples of the method, network entities, and non-transitory computer-readable medium described herein, the set of multiple downlink messages includes a fourth downlink message that may have a last symbol that occurs at a same time as the last symbol of the third downlink message in the time domain, the third downlink message may be associated with a first processing time that may be greater than a second processing time associated with the fourth downlink message, and the first feedback message may be obtained based on the first processing time that may be greater than the second processing time.

In some examples of the method, network entities, and non-transitory computer-readable medium described herein, the first downlink message may be associated with a first processing time that terminates prior to the offset and the second downlink message may be associated with a second processing time that terminates after the offset and the method, apparatuses, and non-transitory computer-readable medium may include further operations, features, means, or instructions for obtaining, via the first feedback message, one or more ACK bits based on the first processing time and obtaining, via a second feedback message associated with the second downlink message, one or more NACK bits based on the second processing time.

In some examples of the method, network entities, and non-transitory computer-readable medium described herein, at least one downlink message of the plurality of downlink messages is associated with a processing time that terminates after the offset, and the method, apparatuses, and non-transitory computer-readable medium may include further operations, features, means, or instructions for obtaining, via at least the first feedback message, one or more NACK bits based on the processing time of the at least one downlink message.

Some examples of the method, network entities, and non-transitory computer-readable medium described herein may further include operations, features, means, or instructions for outputting a second downlink control information message that schedules a second set of multiple downlink messages that includes at least a fourth downlink message via the first cell, a fifth downlink message via the second cell, and a sixth downlink message via the first cell, where at least one downlink message of the second set of multiple downlink messages may be associated with a processing time that terminates after a second offset from a last symbol of the second set of multiple downlink messages and refraining from obtaining a feedback message associated with the fourth downlink message, the fifth downlink message, and the sixth downlink message based on the processing time of the at least one downlink message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports multi-cell and multi-shared channel communications in accordance with one or more aspects of the present disclosure.

FIG. 2 shows an example of a network architecture that supports multi-cell and multi-shared channel communications in accordance with one or more aspects of the present disclosure.

FIG. 3 shows an example of a wireless communications system that supports multi-cell and multi-shared channel communications in accordance with one or more aspects of the present disclosure.

FIG. 4 shows an example of a signaling diagram that supports multi-cell and multi-shared channel communications in accordance with one or more aspects of the present disclosure.

FIG. 5 shows an example of a resource diagram that supports multi-cell and multi-shared channel communications in accordance with one or more aspects of the present disclosure.

FIG. 6 shows an example of a process flow that supports multi-cell and multi-shared channel communications in accordance with one or more aspects of the present disclosure.

FIGS. 7 and 8 show block diagrams of devices that support multi-cell and multi-shared channel communications in accordance with one or more aspects of the present disclosure.

FIG. 9 shows a block diagram of a communications manager that supports multi-cell and multi-shared channel communications in accordance with one or more aspects of the present disclosure.

FIG. 10 shows a diagram of a system including a device that supports multi-cell and multi-shared channel communications in accordance with one or more aspects of the present disclosure.

FIGS. 11 and 12 show block diagrams of devices that support multi-cell and multi-shared channel communications in accordance with one or more aspects of the present disclosure.

FIG. 13 shows a block diagram of a communications manager that supports multi-cell and multi-shared channel communications in accordance with one or more aspects of the present disclosure.

FIG. 14 shows a diagram of a system including a device that supports multi-cell and multi-shared channel communications in accordance with one or more aspects of the present disclosure.

FIGS. 15 through 22 show flowcharts illustrating methods that support multi-cell and multi-shared channel communications in accordance with one or more aspects of the present disclosure.

### DETAILED DESCRIPTION

Some wireless communications systems may utilize one or more downlink control messages (DCIs) to schedule various shared channel communications. A shared channel communication may refer to a message or other signaling that is communicated via a shared channel (e.g., physical uplink shared channel (PUSCH) communications, physical downlink shared channel (PDSCH) communications, shared channel messages). For instance, a user equipment (UE) may receive a DCI in accordance with a format that supports scheduling of a single shared channel communication (e.g., a single PUSCH, or a single PDSCH) message in one or more cells (e.g., DCI format 1_3, DCI format 0_3). In some cases, a “cell” may refer to a logical configuration of time resources and frequency resources for communications between a network entity and one or more UEs. Moreover, in some cases, a cell may be associated with a specific geographic area that corresponds to an area of intended coverage. In some cases, a network entity (e.g., a physical network entity) may configure (e.g., be associated with, allocate resources for) multiple cells, which may be respectively distinguished by an identifier (e.g., a physical cell identifier (PCID)) provided during an initial access procedure (e.g., provided via a primary synchronization signal (PSS) or a secondary synchronization signal (SSS)).

In some cases, some DCI formats may be defined (e.g., by an industry standard, DCI format 1_3, DCI format 0_3)) that enable a network entity, a UE, and other network devices to support a single DCI that schedules (e.g., allocates time and frequency domain resources for) multiple shared channel communications across multiple cells. These multiple cells may be configured for the UE by one or more network entities (e.g., using control signaling mechanisms such as an ServingCellConfig information element (IE) or a ServingCellConfigCommon IE). That is, a single DCI could potentially schedule different shared channel communications on different cells. Additionally, or alternatively, a single DCI could potentially schedule different shared channel communications on a single cell. This capability may be referred to as a multiple cell, multiple shared channel scheduling capability.

However, at least some aspects of a wireless communications system may not be compatible with multiple shared channel scheduling across multiple cells (e.g., may not support a multiple cell, multiple shared channel scheduling capability). For instance, various fields of a DCI message (e.g., new data indicator (NDI) field, redundancy version (RV) field, and other fields) may not support a sufficient quantity of bits (e.g., a maximum quantity of bits) to account for multiple shared channel communications across multiple cells. Moreover, some feedback signaling techniques (e.g., hybrid automatic repeat request (HARQ) feedback) may not be compatible with multiple shared channel communication scheduling across multiple cells. For instance, there may be ambiguity at the UE when determining transmission timing of multiple feedback messages associated with shared channel communications across multiple cells, resulting in reduced coordination between devices, decreased data throughput, and increased processing overhead. Moreover procedures may be undefined at the UE for generating feedback information (e.g., feedback bits) for the multiple feedback messages, resulting in increased latency and reduced communication reliability, among other adverse effects.

In accordance with one or more techniques described herein, a UE, a network entity, and other devices of a wireless communication system may support updated DCI signaling (e.g., by defining new characteristics and interpretations of various DCI fields) and updated feedback mechanisms (e.g., by defining new behavior and rules for a UE to report feedback) that enable multiple shared channel communication scheduling across multiple cells. In some examples, one or more fields of a DCI (e.g., entries of the DCI or some other control message, an NDI field, an RV field) may support a quantity of bits (e.g., a configured or defined quantity of bits, a maximum quantity of bits) that accounts for (e.g., is equal to) a quantity (e.g., a maximum quantity) of shared channel communications across multiple scheduled cells. In some examples, a UE and/or a network entity may support a quantity (e.g., a maximum quantity) of shared channel communications per scheduled cell, (a quantity (e.g., a maximum quantity) of cells, and a quantity (e.g., a maximum quantity) of scheduled shared channel communications over all scheduled cells. In some examples, one or more fields in a DCI message (e.g., in a DCI format 1_3 or 0_3) may be extended (e.g., updated) to support scheduling of multiple shared channel communications for each cell (e.g., as opposed to a single shared channel communication).

Additionally, or alternatively, other information of the DCI (e.g., a frequency domain resource allocation (FDRA), a modulation and coding scheme (MCS), a HARQ process number) may be updated to account for the multi-shared channel communications across multiple cells. For example, various rules that define the characteristics (e.g., maximum bit quantity, indication) and interpretations of such information included in a DCI message may be modified to account (e.g., be applicable to, have defined behavior) for scenarios of multi-shared channel communications across multiple cells. Thus, the UE and the network entity may communicate (e.g., transmit, output, convey, receive, obtain, retrieve, decode) the multiple shared channel communications via multiple cells in accordance with the DCI signaling.

In some examples, a UE may be configured to transmit feedback signaling (e.g., HARQ feedback via a physical uplink control channel (PUCCH) message) in accordance with multiple shared channel communication scheduling across multiple cells. For example, the UE may be configured to generate feedback information (e.g., HARQ-acknowledgment (HARQ-ACK) information bits) using various codebook types (e.g., updated codebook types) that support multiple shared channel communication scheduling across multiple cells. In some examples, the UE may be configured to determine a timing (e.g., based on an offset relative to receipt of a downlink message) for feedback transmission and may prioritize an order of various feedback messages in accordance with the multiple shared channel communications across multiple cells. Accordingly, such techniques may enable the devices of a wireless communications system to support scheduling (e.g., by a single DCI) of multiple shared channel communications across multiple cells of the network.

In some examples, by utilizing updated DCI signaling that supports scheduling of multiple shared channel communications across multiple cells, a UE may be enabled to be scheduled (e.g., by a network entity) with a greater quantity of communications at a time, which may result in increased data rates and improved spectral efficiency. Additionally, a network entity may be enabled to transmit relatively fewer control messages to schedule shared channel communications, resulting in reduced energy consumption. Moreover, by supporting updated feedback signaling, a UE may be enabled to transmit feedback information to a network entity for multiple shared channel communications across multiple cells, resulting in improved communication reliability and improved coordination between devices in a wireless communication system. For example, a UE may receive a single DCI message that schedules multiple shared channel communications across multiple cells, which may increase overall data rates for communications between the UE and the network. Additionally, the network entity may configure and transmit relatively fewer DCI messages overall, which may reduce overall processing at the network and may reduce over-the-air traffic, thus improving power efficiency and reducing traffic congestion over wireless channels.

Aspects of the disclosure are initially described in the context of wireless communications systems. Aspects of the disclosure are further illustrated by and described with reference to signaling diagrams, resource diagrams, process flows apparatus diagrams, system diagrams, and flowcharts that relate to multi-cell and multi-shared channel communications.

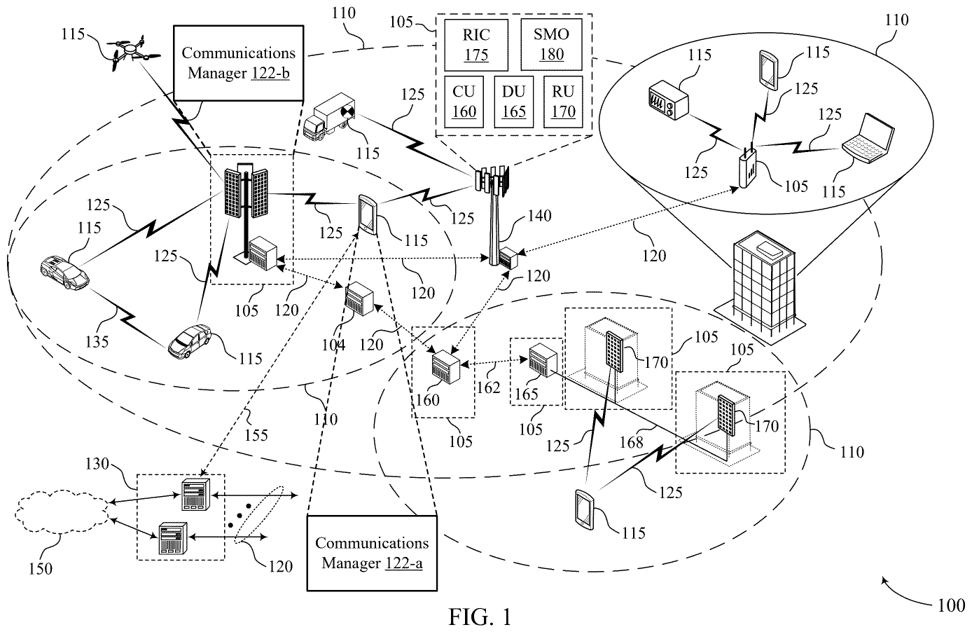

FIG. 1 shows an example of a wireless communications system 100 that supports multi-cell and multi-shared channel communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-A network, an LTE-A Pro network, a NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support multi-cell and multi-shared channel communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a PCID, a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may utilize one or more DCIs to schedule various shared channel communications (e.g., shared channel messages, PDSCHs/PUSCHs). In some cases, a network entity 105, a UE 115, and other network devices may support scheduling of multiple shared channel communications across multiple cells (e.g., associated with one or more network entities 105, using a single DCI). However, various fields of a DCI message may not support a sufficient quantity of bits (e.g., a maximum quantity of bits) to account for multiple shared channel communications across multiple cells, and some feedback signaling techniques (e.g., HARQ feedback) may not be compatible with multiple shared channel communication scheduling across multiple cells, resulting in increased latency, increased processing overhead, and reduced communication reliability, among other adverse effects.

In accordance with one or more techniques described herein, UEs 115, network entities 105, and other devices may support updated DCI signaling and updated UE feedback mechanisms that enable multiple shared channel communication scheduling across multiple cells. In some examples, a UE 115 may include a communications manager 122-a and a network entity 105 may include a communications manager 122-b, which may enable to the respective devices to perform one or more techniques described herein. In some examples, a network entity 105 may, via or in accordance with the communications manager 122-b, transmit a DCI message, where one or more fields of the DCI message may support a configured quantity of bits (e.g., a maximum quantity of bits) that accounts for a quantity of multiple shared channel communications across multiple scheduled cells. Additionally, or alternatively, UEs 115, via or in accordance with the communications manager 122-a, may be configured to communicate feedback signaling in accordance with multiple shared channel communication scheduling across multiple cells. For example, a UE 115, via or in accordance with the communications manager 122-a, may generate feedback information (e.g., HARQ-ACK bits), determine a feedback transmission timing, and prioritize multiple feedback messages in accordance with the multiple shared channel communications across multiple cells. Accordingly, such techniques may enable the devices of the wireless communications system 100 to support scheduling (e.g., by a single DCI) of multiple shared channel communications across multiple cells of the network, resulting in increased data throughput, reduced energy consumption, improved spectral efficiency, and improved communication reliability.

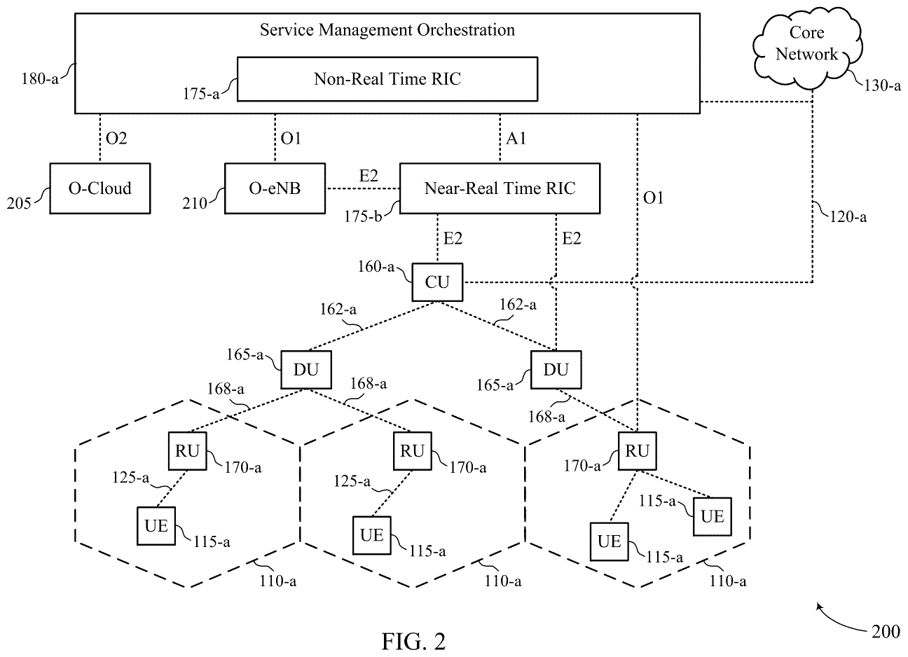

FIG. 2 shows an example of a network architecture 200 (e.g., a disaggregated base station architecture, a disaggregated RAN architecture) that supports multi-cell and multi-shared channel communications in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In some cases, a network entity 105, a CU 160, a DU 165, a RU 170, a UE 115, and other devices may support scheduling of multiple shared channel communications across multiple cells (e.g., associated with one or more coverage areas 110, using a single DCI). However, various fields of a DCI message may not support multiple shared channel communications across multiple cells, and some feedback signaling techniques (e.g., HARQ feedback) may not be compatible with multiple shared channel communication scheduling across multiple cells. Thus, as described herein, UEs 115, devices of the network architecture 200 may support updated DCI signaling and updated UE feedback mechanisms that enable multiple shared channel communication scheduling across multiple cells. For example, one or more fields of a DCI may support a configured quantity of bits that accounts for a quantity of multiple shared channel communications across multiple scheduled cells. Additionally, or alternatively, UEs 115 may be configured to communicate feedback signaling in accordance with multiple shared channel communication scheduling across multiple cells. Accordingly, such techniques may enable the network architecture 200 to support scheduling (e.g., by a single DCI) of multiple shared channel communications across multiple cells, resulting in increased data throughput, reduced energy consumption, improved spectral efficiency, and improved communication reliability.

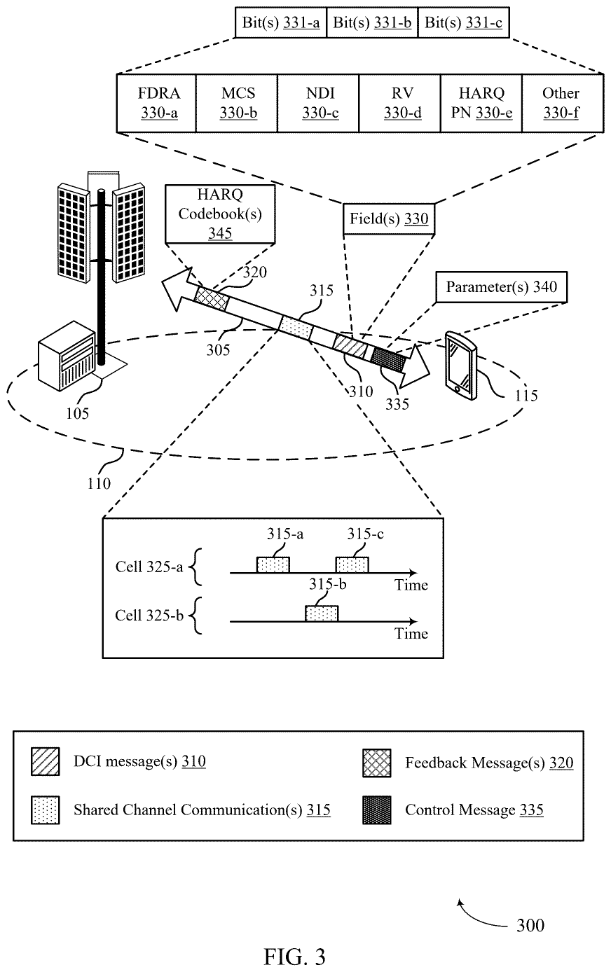

FIG. 3 shows an example of a wireless communications system 300 that supports multi-cell and multi-shared channel communications in accordance with one or more aspects of the present disclosure. For example, the wireless communications system 300 may include a UE 115, a network entity 105, or other devices (not shown) as described with reference to FIGS. 1 and 2. The network entity 105 may communicate various messages and signaling with one or more UEs 115 within the coverage area 110 via a communication link 305. The communication link 305 may be an example of (or include) a downlink communication interface, an uplink communication interface, other communication interfaces, or a combination thereof. For example, the network entity 105 may communicate one or more DCI messages 310 (e.g., via a physical downlink control channel (PDCCH)) to the UE 115, which may schedule one or more shared channel communications 315 (e.g., one or more PDSCH messages, one or more PUSCH messages, a PxSCH message) via the communication link 305. In some examples, the UE 115 may transmit one or more feedback messages 320 (e.g., via a PUCCH) associated with the one or more shared channel communications 315 (e.g., one or more PDSCHs).

In some cases, a DCI message 310 may be transmitted in accordance with various formats. Some formats (e.g., DCI format 1_3 or 0_3) may be used to schedule a shared channel communication 315 for one or more cells 325 (e.g., cells associated with one or more network entities 105). In some cases, one or more network entity 105 may configure the one or more cells 325 (e.g., both the network entity 105 may configure the cell 325-a and the cell 325-b), or multiple network entities 105 may configure the one or more cells (e.g., the network entity 105 may configure the cell 325-a and another network entity (not show) may configure the cell 325-b). In some cases, such formats may be used to schedule a single shared channel communication 315-a on a cell 325-a and a single shared channel communication 315-b on a cell 325-b (e.g., one PDSCH/PUSCH per cell may be configured). In some cases, the UE 115 may be configured with multiples sets of cells 325, and other control signaling (e.g., RRC signaling, a control message 335) may configure the UE 115 to monitor one or more DCI formats (e.g., format 1_3 and 0_3, in one or more cells 325) that schedules communications across multiple cells (e.g., for a set of cells 325 that is configured at the UE 115). For instance, the UE 115 may receive a control message 335 indicating one or more parameters 340. The one or more parameters 340 may indicate one or more sets of cells 325 (e.g., in accordance with a parameter 340 of one or more IEs, MC-DCI-SetofCells) and a target set of cells 325 (e.g., via another parameter 340 or identifier, setofCellsId-r18) of the multiple sets. In some cases, the UE 115 may also receive one or more parameters 340 (e.g., nCI-Value-r18, via the control message 335) that identifies each set of cells 325, and the UE 115 may use these parameters 340 (e.g., as part of a PDCCH hashing function) to retrieve one or more PDCCH candidates for receiving a DCI message 310 (e.g., used for communicating the DCI messages 310 with format 1_3 or 0_3).

In some cases, the UE 115 may receive multiple combinations of scheduled cells 325 in each set of cells 325 (e.g., via MC-DCI-SetofCells IEs). A scheduled cell 325 may refer to a cell 325 in which at least one communication (e.g., shared channel communications 315) is scheduled (e.g., by a DCI message 310) to occur between two or more devices (e.g., the UE 115 and the network entity 105). In some cases, a parameter 340 may include a scheduled cell set indicator (e.g., in DCI formats 1_3/0_3, if scheduledCellComboListDCI-X-3 is configured, where X={0,1}), which may configure the set of cells 325 for the one or more shared channel communications 315 (e.g., for PDSCH/PUSCH transmission). Additionally, a quantity of FDRA entries (e.g., an FDRA table) in the DCI message 310 (e.g., in a DCI format 1_3/0_3), which may correspond to the set of cells 325 (e.g., within scheduledCellListDCI-X-3, if scheduledCellComboListDCI-X-3 is not configured), may configure the set of cells 325 to be used by the UE 115.

In some cases, the DCI message 310 may include one or more fields 330, which may be associated with various configuration information (e.g., control parameters) for the shared channel communications 315. For example, the one or more fields 330 may include an FDRA field 330-a, an MCS field 330-b, an NDI field 330-c, an RV field 330-d, a HARQ process number (PN) field 330-e, one or more other fields 330-f, or any combination thereof. Such fields may be specified for each of the cells 325 and time domain resource allocation (TDRA) may be specified for each BWP of each cell 325. In some cases, HARQ-ACK codebooks 345 may be modified to provide HARQ-ACK information bits for the different PDSCHs in the respective different cells 325. In some cases, each field 330 may include a respective quantity of bits, which may be applicable to various shared channel communications 315 and various cells 325. As a non-limiting example, the field(s) 330 may include one or more bits 331-a associated with a shared channel communication 315-a via the cell 325-a, one or more bits 331-b associated with a shared channel communication 315-b via the cell 325-b, and one or more bits 331-c associated with a shared channel communication 315-c via the cell 325-a.

The wireless communications system 300 may further support a DCI message 310 that schedules multiple shared channel communications 315 across multiple cells 325. A shared channel communication 315 may include a PUSCH message, a PDSCH message, or some other message communicated via shared channel message. In some cases, each cell 325 (e.g., a cell 325-a and a cell 325-b) may be associated with the network entity 105 or may be associated with multiple network entities 105.

In some cases, one or more DCI formats (e.g., DCI format 1_3 and/or 0_3) use for a DCI message 310 may be extended to enable simultaneous scheduling of shared channel communications 315 for at least two cells 325 (e.g., a scheduling of multiple shared channel communications 315 for at least two cells 325 using a single DCI message 310), where at least one of the cells is scheduled with at least two shared channel communications 315 (e.g., which may be referred to as multi-cell multi-PxSCH scheduling). As an illustrative example, a DCI message 310 may schedule at least: a shared channel communication 315-a via the cell 325-a, a shared channel communication 315-b via the cell 325-b, and a shared channel communication 315-c via the cell 325-a. In some cases, the UE 115 may not expect both single-cell multi-PUSCH/PDSCH scheduling and multi-cell multi-PUSCH/PDSCH scheduling on a same cell 325 (e.g., a cell 325-a or a cell 325-b) or different cells 325 (e.g., within a same group of one or more DCI messages 310, such as a PUCCH group). Moreover, the UE 115 UE may expect a same subcarrier spacing (SCS) or carrier-type, or a different SCS or carrier-type across cells 325, and may not expect same or different SCS or carrier-type across multiple PDSCH/PUSCHs within a particular cell 325 (e.g., a multi-cell multi-PUSCH/PDSCH scenario may be ambiguous at the UE 115). Thus, at least some aspects of the wireless communications system 300 may not support scheduling of multiple shared channel communications 315 across multiple cells 325.

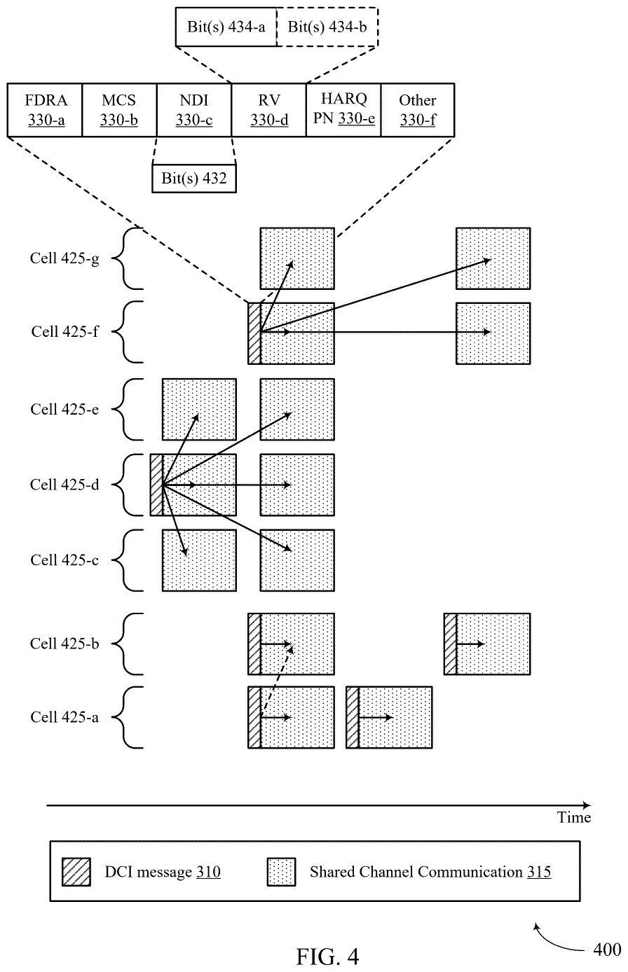

As described herein, the wireless communications system 300 may support various techniques that enable multiple shared channel communications 315 across multiple cells 325. For example, the UE 115 and the network entity 105 may utilize a DCI message 310 that includes one or more fields 330 (e.g., in the DCI format) and other information that accounts for the multi-PDSCH/PUSCH scheduling across multiple cells 325. Additionally, or alternatively, the UE 115 and the network entity 105 may support an RRC configuration (e.g., such as updated TDRA tables mimicking those in pdxsch-TimeDomainAllocationListForMultiPDSCH/PUSCH) that supports such functionality. Such aspects may be described in greater detail herein, including with reference to FIG. 4.

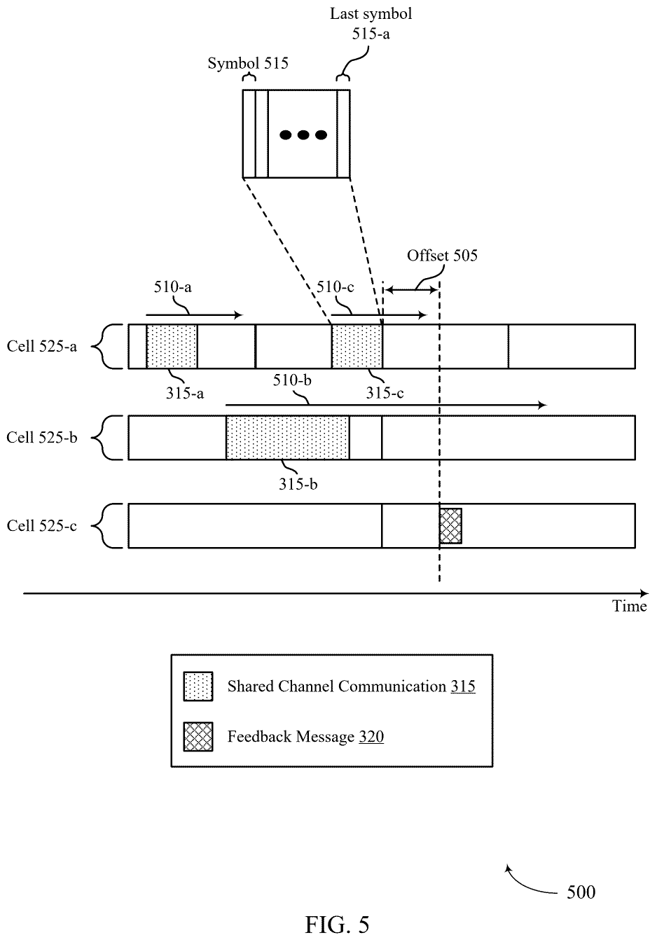

Additionally, or alternatively, the UE 115 and the network entity 105 may support communication of one or more feedback messages 320 that support scheduling of multiple shared channel communications 315 across multiple cells 325. For example, the UE 115 may support codebook generation techniques (e.g., HARQ-ACK codebook generation, for DCI formats 1_3/0_3) such that the information of the feedback messages 320 (e.g., HARQ-ACK information bits, corresponding to the transport blocks (TBs) transmitted in multiple PDSCHs for a given cell 325) is included in the codebook. Moreover, the UE 115 may support a determination of a reference shared channel communication 315 (e.g., a reference PDSCH) used for determining the transmission of the one or more feedback messages 320 (e.g., for processing time computation and HARQ-ACK reporting in the PUCCH). Such aspects may be described in greater detail herein, including with reference to FIG. 5.

In some examples, by utilizing a DCI message 310 that schedules multiple shared channel communications 315 across multiple cells 325, the UE 115 may be scheduled (e.g., by the network entity 105) with a greater quantity of messages at a time. Accordingly, the wireless communications system 300 may experience increased data rates and improved spectral efficiency. Additionally, the network entity 105 may transmit relatively fewer DCI message 310, resulting in reduced energy consumption of the wireless communications system 300. Moreover, by transmitting one or more feedback messages 320 as described herein, the UE 115 may transmit coordinated feedback information for multiple shared channel communications 315 across multiple cells 325, resulting in improved communication reliability and improved coordination between devices in the wireless communications system 300.

FIG. 4 shows an example of a signaling diagram 400 that supports multi-cell and multi-shared channel communications in accordance with one or more aspects of the present disclosure. In some examples, aspects of the signaling diagram 400 may implement or be implemented by the wireless communications system 100, the network architecture 200, and the wireless communications system 300 as described with reference to FIGS. 1 through 3. For example, a UE 115, a network entity 105, or some other device may support various aspects of the signaling diagram 400, which may illustrate communication of various DCI messages 310 and shared channel communications 315 across multiple cells 425 (e.g., cells 325, component carriers (CCs)) in a time domain.

In some cases, a DCI message 310 may schedule (e.g., allocate time and frequency resources for) a single shared channel communication 315 (e.g., for a single cell 425 or for multiple cells 425), such as in the example of the DCI messages 310 in cell 425-a and cell 425-b. However, other DCI messages 310 (e.g., in accordance with a DCI format 1_3 or 0_3) may schedule one or more shared channel communications 315 across one or more cells 425, such as in the example of the DCI messages 310 in cell 425-d and cell 425-f. As an illustrative example, the DCI message 310 communicated via cell 425-d may schedule one or more first shared channel communications 315 for cell 425-c, one or more second shared channel communications 315 for cell 425-d, and one or more third shared channel communications 315 for cell 425-e. As another example, the DCI message 310 communicated via cell 425-f may schedule one or more first shared channel communications 315 for cell 425-f and one or more second shared channel communications 315 for cell 425-g. That is, the DCI messages 310 communicated via cell 425-d and cell 425-f may support scheduling of multi-cell and multi-PUSCH/PDSCH communication.

In some examples, a UE 115 and a network entity 105 may utilize various techniques herein to support the scheduling of multi-cell and multi-PUSCH/PDSCH communication (e.g., based on the DCI messages 310 communicated via cell 425-d or cell 425-f). For example, various DCI signaling techniques herein may support scheduling of multiple shared channel communications 315 via multiple cells 425. In some examples, a UE 115 and/or a network entity 105 may support a quantity (e.g., a maximum quantity) of PUSCHs/PDSCHs per scheduled cell 425 (e.g., a first parameter,

$${N}_{P D S C H / P U S C H}^{cell} ) ,$$

a quantity (e.g., a maximum quantity) of cells 425 (e.g., a second parameter,

$${N}_{cells}^{m ax} ) ,$$

and a quantity (e.g., a maximum quantity) of scheduled PUSCHs/PDSCHs (e.g., shared channel communications 315) over all scheduled cells 425 (e.g., a third parameter,

$${N}_{P D S C H / PUSCH}^{m ax} ) .$$

In some examples, one or more fields 330 in a DCI message 310 (e.g., in a DCI format 1_3 or 0_3) may be extended (e.g., updated) to support scheduling of multiple shared channel communications 315 (e.g., PUSCHs, PDSCHs, PDSCH/PUSCHs) for each cell 425 (e.g., as opposed to a single shared channel communication 315).

In some examples, an NDI field 330-c (e.g., an existing NDI field may be updated, or a new NDI field may be defined) of a DCI format (e.g., formats 1_3 and/or 0_3) may support a maximum quantity of bits 432 (e.g., bits 331). In some examples, each bit 432 may indicate whether new data is being communicated via the shared channel communication 315. The maximum quantity of bits 432 in the NDI field 330-c may be associated with (e.g., defined or selected to be equal to) a maximum quantity of scheduled shared channel communications 315 across each scheduled cell 425 (e.g., may be equal to

$${N}_{P D S C H / PUSCH}^{m ax} ) .$$

In some examples, a quantity of cells 425 may be indicated (e.g., explicitly, by a network entity 105) by one or more control parameters (e.g., scheduledCellComboListDCI-X-3 or scheduledCellListDCI-X-3), which may affect how FDRA information, MCS information, NDI information, and RV information is interpreted by the UE 115 for the different TBs being scheduled for the different shared channel communications 315 in different cells 425. Such techniques (e.g., an indication to the UE 115 of how many cells 425 and which cells 425 are being scheduled) may be extended to other fields 330 in a DCI message 310 (e.g., which may reduce overhead).

In some examples, the fields 330 may include an RV field 330-d, which may include one or more blocks of bits 434 (e.g., bits 331, a block of bits 434-a and a block of bits 434-b), which may each be respectively associated with a shared channel communications 315 (e.g., a respective TB) or a portion of a multiple shared channel communications 315 (e.g., a block of bits 434-a may be associated with the shared channel communication 315-a or and a block of bits 434-b may be associated with the shared channel communication 315-b, or respective portions thereof). For example, the RV field 330-d may include multiple blocks of bits 434 such as: block 1 cell 1, block 2 cell 1, . . . , block N1 cell 1, block 1 cell 2, . . . , block N2 cell 2, . . . , block 1 cell N_{cells}, block N_{N}_{_{cells}} cell N_{cells}, where Nⱼ may indicate a quantity of shared channel communications 315 (e.g., PDSCH/PUSCHs) for cell j (e.g., for a given cell 425) and N_{cells} may indicate a total quantity of scheduled cells 325. In some examples, N_{cells} may be obtained via the one or more control parameters (e.g., scheduledCellComboListDCI-X-3 or scheduledCellListDCI-X-3), and the quantity of PDSCH/PUSCHs for cell j may be indicated by a quantity of entries in a row of a TDRA table (e.g., a joint TDRA, a look-up table, a set of time domain resources). In some examples, a TDRA table may configure a set of time domain allocation resource for multiple shared channel communications 315 in multiple BWPs of the multiple cells 425 (e.g., assuming that active BWPs may be scheduled).

The RV field 330-d may be associated with a maximum quantity of bits 434, which may be based on one or more control parameters (e.g., numberOfBitsForRV-DCI-X-3) and the maximum quantity of scheduled shared channel communications 315 across each scheduled cell 425 (e.g., the maximum quantity of scheduled PDSCH/PUSCHs). In some examples, a quantity of bits 434 used for each block of the RV field 330-d may be configured (e.g., defined, selected) to be equal to (e.g., the same as) a quantity of bits for each shared channel communication 315 in a given cell 425. In such examples, the quantity of bits 434 for each block may by indicated to the UE 115 (e.g., via an RRC indication of the quantity of bits using numberOfBitsForRV-DCI-X-3). Additionally, or alternatively, the quantity of bits 434 used for each block may be a different quantity of bits 434 for each shared channel communication 315 in a cell 425. In such examples, the quantity of bits 434 for each block may be indicated to the UE 115 for each cell (e.g., via an RRC indication of the quantity of bits for each shared channel communication 315 for each cell 425), and an association of a quantity of bits to a given shared channel communication 315 may be based on (e.g., given by) an increasing order of a column index in a particular row of the joint TDRA table, or based on an increasing order of reception or transmission time of the shared channel communications 315.

Additionally, or alternatively, the DCI message 310 may include other fields 330 to indicate information used for communication of the shared channel communications 315. In some examples, an FDRA field 330-a may include FDRA information for each shared channel communication 315 on a given cell 425 (e.g., and may be commonly indicated for all shared channel communications 315 on the give cell 425). Similarly, an MCS field 330-b may include MCS information for each shared channel communication 315 on a given cell 425 (e.g., and may be commonly indicated for all shared channel communications 315 on the give cell 425). For example, a DCI message 310 may indicate first FDRA and MCS information for each PUSCH/PDSCH message on a cell 425-d and may indicate second FDRA and MCS information for each PUSCH/PDSCH message on a cell 425-e (e.g., different than the first FDRA and MCS information). In some examples, a HARQ PN field 330-e may include HARQ process information for each cell 425. For example, the DCI message 310 may indicate first HARQ information for a cell 425-d and may indicate second HARQ information for a cell 425-e (e.g., different than the first HARQ information).

Accordingly, by including various fields 330 in a DCI message 310 that account for scheduling of multiple shared channel communications 315 via multiple cells 425, a UE 115 and a network entity 105 may support increased data throughput, reduced processing overhead, and improved spectral efficiency. For example, such technique may enable a UE 115 to communicate a relatively greater quantity of shared channel communications 315 based on a single DCI message 310. Moreover, a network entity 105 may transmit relatively fewer DCI messages, thus reducing power consumption and channel traffic in a wireless communication system.

FIG. 5 shows an example of a resource diagram 500 that supports multi-cell and multi-shared channel communications in accordance with one or more aspects of the present disclosure. In some examples, aspects of the resource diagram 500 may implement or be implemented by the wireless communications system 100, the network architecture 200, the wireless communications system 300, and the signaling diagram 400 as described with reference to FIGS. 1 through 4. For example, a UE 115, a network entity 105, or some other device may support various aspects of the resource diagram 500, which may illustrate communication of various shared channel communications 315 and feedback messages 320 across multiple cells 525 (e.g., cells 325, cells 425, CCs) in a time domain.

As described herein, a UE 115 may support feedback techniques that enable scheduling of multiple shared channel communications 315 across multiple cells 525. For example, the UE 115 may support various codebook generation operations for transmission of one or more feedback messages 320 associated with multiple shared channel communications 315 across multiple cells 525. For a first type of codebook generation (e.g., Type-1 codebook generation, generation of one or more bits), a set of configured time domain resources (e.g., TDRA tables, or in accordance with some other ordering of PDSCH receptions) may be updated to include various entries that support taken multiple shared channel communications 315 via multiple cells 525. In some examples, a TDRA table may specify one entry per BWP per cell for each of the configured BWPs in each cell 525. A UE 115 may use an entry in the TDRA table that corresponds to an active BWP in the cell 525 (e.g., and may ignore the entry of the other BWPs that are inactive) as one BWP may be active at a time for a particular cell 525. The UE 115 may use such sets of resources to determine resources (e.g., PDSCH occasions) for generation of feedback information (e.g., HARQ-ACK information bit generation). For a second type of codebook generation (e.g., Type-2 codebook generation), feedback information bits (e.g., HARQ-ACK information bits corresponding to PDSCHs received on multiple cells 525) may be indicated via a sub-codebook (e.g., the second sub-codebook) of a set of multiple sub-codebooks configured at the UE 115 (e.g., with an additional loop operation iterating over each of the different multiple received PDSCHs in a particular cell 525).

In some examples, a UE 115 may receive two or more DCI messages 310 during a same monitoring occasion (e.g., more than one PDCCH may be received at the same time, and each PDCCH may schedules multiple PDSCHs on multiple cells 525). In such examples, if a UE 115 indicates type 2-HARQ-ACK-Codebook and receives

$${N}_{PDSCH , c}^{m} > 1 PDSCHs$$

on a serving cell c that are scheduled by

$${N}_{PDSCH , c}^{m}$$

DCI formats 1_3 in PDDCH repetitions at a same PDCCH monitoring occasion m, (where each of the DCI formats 1_3 schedules more than one PDSCH receptions on respective more than one serving cells, c is the smallest cell index among the respective more than one serving cells, and c is same across the

$${N}_{PDSCH , c}^{m}$$

DCI formats 1_3), the serving cell c may be counted

$${N}_{PDSCH , c}^{m}$$

times for PDCCH monitoring occasion m in increasing order of the PDSCH reception starting time among the

$${N}_{PDSCH , c}^{m}$$

receptions.

However, reporting one or more feedback messages 320 (e.g., HARQ-ACK information bits) may not be defined for scenarios of multiple shared channel communications 315 (e.g., PDSCHs) scheduled via multiple cells 525. For instance, feedback mechanisms may not be defined for scenarios in which multiple PDCCHs are received on a same PDCCH monitoring occasion (e.g., where each PDCCH schedules one or more PDSCH receptions on multiple serving cells 525) and at least two of the total scheduled PDSCHs are scheduled on a same serving cell 525 (e.g., across the multiple serving cells 525 configured in a corresponding set of serving cells 525), and the two or more of the scheduled PDSCHs may be scheduled by different PDCCH candidates falling within the same PDCCH monitoring occasion or by a same PDCCH candidate in that monitoring occasion. In some examples, a UE 115 may order multiple feedback messages 320 (e.g., ordering of HARQ-ACK information bits) for a serving cell in which multiple PDSCH receptions are scheduled based on an increasing order of PDSCH reception starting time.

Additionally, or alternatively, the UE 115 may support other techniques for the reporting of feedback messages 320 (e.g., when two or more PDCCH candidates with DCI format 1_3 or 0_3 fall within a same monitoring occasion, and may also be compatible with conventional techniques). In a first example, HARQ-ACK information bits (e.g., included in a feedback message 320) may be reported in accordance with a sequence (e.g., a defined sequence or ordering). As a non-limiting example, the sequence may be ordered in accordance with the following: first, in an ascending order of a codeword index for a given PDSCH; second, in an increasing order of a starting reception time for the PDSCHs received on a given cell 525; third, in an increasing order of a serving cell index; fourth, in an order of PDCCH candidates in a same PDCCH monitoring occasion, where an ordering of PDCCH candidates for HARQ-ACK reporting may be done by ascending or descending order of an aggregation level, a search space index, a CORESET index, an earliest control channel element (CCE) index in CORESET for both PDCCH candidates in the same monitoring occasion or any combination thereof; and fifth, in an increasing order of PDCCH monitoring occasion reception time. Alternatively, the sequence may be ordered different than the non-limiting example. For example, an order of the sequence may include a different ordering that uses the same (or similar) criteria, but prioritized in a different order than described.

In a second example, one or more feedback messages 320 may be prioritized based on and order of PDSCH reception start time. For example, if multiple PDSCHs are received on a first cell 525 (e.g., including one or more first PDSCHs scheduled by a first PDCCH candidate and one or more second PDSCHs scheduled by a second PDCCH candidate), and the multiple PDSCHs are scheduled from different PDCCH candidates, the first cell 525 may be counted as many times as the quantity of PDSCHs received on the first cell 525. In such examples, an ordering of the PDSCHs may be done first, in an increasing (e.g., or decreasing) order of the PDSCH reception starting time among the multiple PDSCHs received in the first cell 525, and second, in an ascending (e.g., or descending) order of serving cell index, PDCCH monitoring occasion index, and or PDSCH codeword index.

In some examples, a UE 115 may support bundling of one or more feedback information bits (e.g., based on spatial bundling, time bundling, or both). In such examples (e.g., if bundling is supported), the UE 115 may bundle (e.g., combine) two or more bits (e.g., HARQ-ACK bits) in accordance with a binary AND operation. In some examples, the two or more bits may correspond to the different TBs, different PDSCHs, or both. Accordingly, the UE 115 may support generation of one or more bundled bits for one or more feedback messages 320.

In some examples, a UE 115 may report a feedback message 320 in accordance with a processing time 510 (e.g., a processing time 510-a, a processing time 510-b, a processing time 510-c) of a shared channel communications 315 (e.g., PDSCH processing time for HARQ-ACK reporting on PUCCH). In some cases, the UE 115 may identify a reference PDSCH to determine the timing of a PUCCH that carries corresponding HARQ-ACK information. In such cases, the reference PDSCH may be the PDSCH that ends last (e.g., as indicated in DCI format 1_3) among the set of co-scheduled PDSCHs. As an illustrative example, if a first uplink symbol of the PUCCH which carries the HARQ-ACK information, as defined by the assigned HARQ-ACK timing, K₁ and K_{offset}, if configured, and the PUCCH resource to be used and including the effect of the timing advance, starts no earlier than at symbol L₁, where L₁ is defined as a next uplink symbol with its cyclic prefix (CP) starting after T_{proc,1}=(N₁+d_{1,1}+d₂+d₃)(2048+144)·κ2^{-μ}·T_{C}+Tₑₓₜ after the end of the last symbol of the PDSCH carrying the TB being acknowledged, then the UE 115 may provide a valid HARQ-ACK message. For a PDSCH with disabled HARQ-ACK feedback, T_{proc,1}=(N₁+d_{1,1}+d₂)(2048+144)·κ2^{-μ}·T_{C}+Tₑₓₜ. In such examples, N1 may be based on u, which may be based on a processing capability of the UE 115 and may correspond to the one of (μ_{PDCCH},μ_{PDSCH},μ_{UL}) resulting with the largest T_{proc,1}. The μ_{PDCCH} may correspond to the SCS of the PDCCH scheduling the PDSCH, the μ_{PDSCH} may correspond to the SCS of the scheduled PDSCH, and the μ_{UL} may correspond to the SCS of the uplink channel with which the HARQ-ACK is to be transmitted, and k may be a defined constant value.

In some examples, each shared channel communication 315 may have a respective quantity of symbols 515 (e.g., PDSCH symbols) including a respective last symbol 515-a. To compute a timing of a feedback message 320 (e.g., a PUCCH carrying HARQ-ACK information), a reference PDSCH (e.g., a reference shared channel communication 315) may be a PDSCH that ends last (e.g., a PDSCH with a last symbol 515-a that occurs after other symbols 515 of other PDSCHs, a PDSCH that is received last at the UE 115) across the multiple PDSCHs (e.g., as indicated in DCI format 1_3 or 0_3) of the cells 525 (e.g., a cell 525-a, a cell 525-b, and a cell 525-c). That is, the UE 115 may transmit the one or more feedback messages 320 in accordance with an offset 505, where the offset 505 is computed (e.g., determined, calculated) based on a reference PDSCH (e.g., the shared channel communication 315-c) that occurs last of the scheduled PDSCHs (e.g., the shared channel communication 315-a, the shared channel communication 315-b, and the shared channel communication 315-c).

In some examples, if more than one PDSCH ends last among the set of co-scheduled PDSCHs, the UE 115 may determine the reference PDSCH based on the PDSCH among the multiple PDSCHs ending last and that results in a largest processing time 510 (e.g., T_{proc,1}, accounting for the parameters N1, d_{1,1}, d₂, d₃ that depend on the SCS and the TDRA), which may provide sufficient processing time for the UE 115 to perform HARQ-ACK reporting. In some examples, the parameter, N₁, may be a PDSCH processing (decoding) time measured in a quantity of symbols 515 and may depend on a UE capability and an SCS. The parameter, d_{1,1}, may be based on a quantity of PDSCH symbols allocated for a PDSCH reception and the UE capability. The parameter, d₂, may be based on an overlap between a PUCCH with a relatively larger priority index with a PUCCH or a PUSCH of a relatively smaller priority index. The parameter, d₃, may be based on whether the UE 115 is configured with a demodulation reference signal (DMRS) enhancement for UE capability.

In some examples, a processing time 510 may extend beyond an uplink symbol for the feedback message 320 (e.g., the PUCCH, the processing time 510-b for the shared channel communication 315-b). In such examples, a UE 115 may report (e.g., transmit) one or more HARQ-ACK bits (e.g., via one or more feedback messages 320) for any shared channel communications 315 (e.g., the PDSCH(s)) whose processing time 510, T_{proc,1}, is such that a start of the PUCCH resource occurs later than T_{proc,1}+t_{end}, where t_{end} may be the end of a last symbol (e.g., a last symbol 515-a) carrying the corresponding PDSCH(s) (e.g., a last symbol of the shared channel communication 315-c), and the UE 115 may report one or more NACK bits for any shared channel communications 315 whose T_{proc,1}+t_{end} occurs later than the start of the PUCCH resource. For example, the UE 115 may report NACK bits for any shared channel communication 315 (e.g., shared channel communication 315-b) whose processing time 510 extends beyond a start time of the feedback messages 320 (e.g., in accordance with the offset 505) and may report ACK bits for any shared channel communication 315 whose processing time 510 finishes before the start of the feedback messages 320 (e.g., the shared channel communication 315-a and the shared channel communication 315-c).

Alternatively, if any PDSCH(s) within a set of scheduled PDSCH(s) results in processing time 510, T_{proc,1}, such that T_{proc,1}+t_{end} is later than the start of the PUCCH resource for the feedback message 320, the UE 115 may generate NACK bits for all the scheduled PDSCH(s) (e.g., by a same DCI message 310 or DCI format 1_3 or 0_3 with same or different SCSs). For example, if a DCI message 310 scheduled the shared channel communication 315-a, the shared channel communication 315-b, and the shared channel communication 315-c, and the processing time 510-b extends beyond the start time of the feedback message 320, the UE 115 may include NACK bits for each of the shared channel communications 315 in the feedback message 320. Alternatively (e.g., instead of generating NACK bits), the UE 115 that received a DCI message 310 (e.g., the DCI format 1_3 or 0_3) for the shared channel communications 315 may ignore the DCI message 310 and may refrain from reporting any HARQ-ACK feedback (e.g., refrain from transmitting one or more feedback messages 320) on a scheduled PUCCH resource (e.g., for PDSCH(s) with the same or different SCSs scheduled by that DCI format 1_3). For example, the UE 115 may refrain from transmitting a feedback message for the shared channel communication 315-a, the shared channel communication 315-b, and the shared channel communication 315-c based on the processing time 510-b extending beyond the start time of the PUCCH resource.

Accordingly, by transmitting one or more feedback messages 320 in accordance with an offset 505, the UE 115 may account for scheduling of multiple shared channel communications 315 via multiple cells 525, which may support increased data throughput and improved spectral efficiency. Moreover, a UE 115 may be configured to report ACK bits or NACK bits based on a processing time 510, which may improve feedback information for a network entity 105, which may support more-efficient scheduling by the network and may result in improved coordination between device in a wireless communication system.

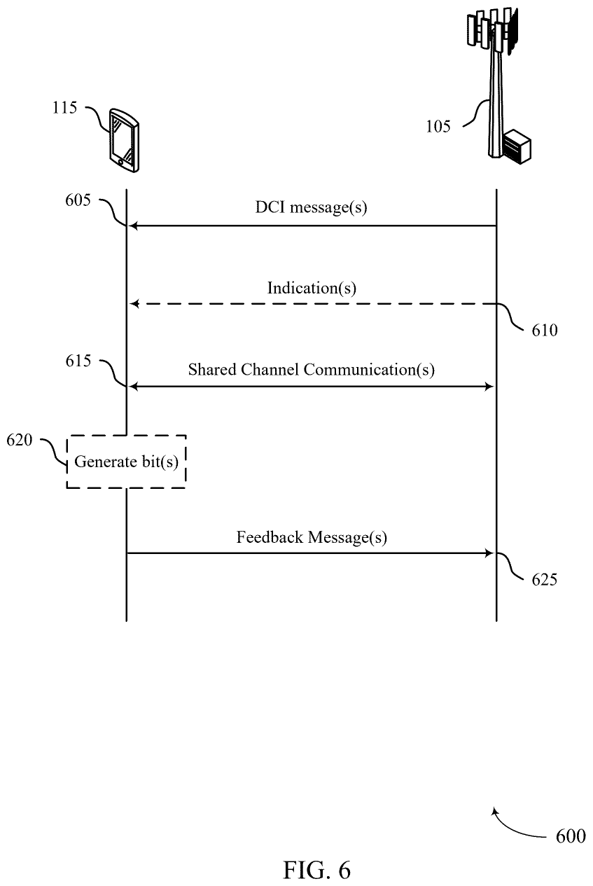

FIG. 6 shows an example of a process flow 600 that supports multi-cell and multi-shared channel communications in accordance with one or more aspects of the present disclosure. In some examples, the process flow 600 may implement aspects of the wireless communications system 100, the network architecture 200, the wireless communications system 300, the signaling diagram 400, and the resource diagram 500. For example, the process flow 600 may support signaling between a UE 115 and a network entity 105, which may be examples of corresponding devices described herein, including with reference to FIGS. 1 through 5. In the following description of the process flow 600, the operations between the UE 115 and the network entity 105 may be performed in a different order than the order shown, or other operations may be added or removed from the process flow 600. For example, some operations may also be left out of the process flow 600, or may be performed in different orders or at different times. Further, although some operations or signaling may be shown to occur at different times for discussion purposes, these operations may actually occur at the same time. Although the UE 115 and the network entity 105 are shown performing the operations of the process flow 600, some aspects of some operations may also be performed by one or more other wireless or network devices.

At 605, the UE 115 may receive one or more DCI messages (e.g., DCI messages 310, a PDCCH message), which may be output (e.g., transmitted) by the network entity 105. For example, the UE 115 may receive a DCI message that schedules at least a first shared channel communication (e.g., shared channel communication 315, PDSCH, PUSCH, a downlink message, an uplink message) via a first cell, a second shared channel communication via a second cell, and a third shared channel communication via the first cell (e.g., cells 325, cells 425, cells 525, the first cell and the second cell may be associated with the network entity 105, or with some other network entity, or both, the first cell may be different from the second cell). In some examples, the DCI message may include one or more fields (e.g., fields 330) that are applicable to the first shared channel communication, the second shared channel communication, and the third shared channel communication (e.g., multiple shared channel communications across multiple cells). In some examples, the one or more fields may have a maximum quantity of bits (e.g., bits 331) that is based on a maximum quantity of scheduled shared channel communications associated with at least the first cell and the second cell.

In some examples, the one or more fields may include an NDI field (e.g., NDI field 330-c), and the maximum quantity of bits (e.g., bits 432) may be selected (e.g., selected by the UE 115, based on a rule definition or a configuration) for the NDI field based on the maximum quantity of scheduled shared channel communications. Additionally, or alternatively, the one or more fields may include an RV field (e.g., RV field 330-d). In such examples, the UE 115 may receive an indication of a quantity of bits associated with the field (e.g., via an RRC message or some other control indication), and a maximum quantity of bits may be selected for the field based on the maximum quantity of scheduled shared channel communications and on the quantity of bits. In some examples, an RV field may include a set of multiple blocks of bits (e.g., blocks of bits 434). Each block of bits of the set of multiple blocks of bits may be associated with a respective shared channel communication and may have a respective quantity of bits that corresponds to the quantity of bits (e.g., each block may have a same quantity of bits for each PDSCH/PUSCH). Alternatively, each block of bits of the set of multiple blocks of bits may be associated with a respective shared channel communication and has a respective quantity of bits, and the indication of the quantity of bits may include each respective quantity of bits for each shared channel communication of each cell (e.g., each block may have a different quantity of bits for each PDSCH/PUSCH).

In some examples, the UE 115 may receive, via the DCI message, one or more second fields applicable to the first shared channel communication, the second shared channel communication, and the third shared channel communication. A second field may include information associated with FDRA (e.g., an FDRA field 330-a), an MCS (e.g., an MCS field 330-b), some other control information, or any combination thereof. In some examples, the second field may indicate a first FDRA, a first MCS, or both for the first shared channel communication and the third shared channel communication (e.g., FDRA and MCS may be common to each PUSCH/PDSCH on a same cell). The second field may also indicate a second FDRA, a second MCS, or both for the second shared channel communication (e.g., FDRA and MCS may be different across cells). Additionally, or alternatively, a second field (e.g., a HARQ PN field 330-e) may include information that indicates a first HARQ PN for the first shared channel communication and the third shared channel communication and indicates a second HARQ PN for the second shared channel communication (e.g., HARQ PN may be indicated per cell).

Additionally, or alternatively, the UE 115 may receive a DCI message (e.g., a DCI message 310, a PDCCH message) that schedules a set of multiple downlink messages, which may be output by the network entity 105. In some examples, the set of multiple downlink messages may include at least a first downlink message via a first cell, a second downlink message via a second cell, and a third downlink message via the first cell. In some examples, a last symbol (e.g., a last symbol 515-a) of the third downlink message may occur after the first downlink message and the second downlink message in a time domain (e.g., the third downlink message may have a receive time that occurs last among the messages indicated in the set). In some examples, the UE 115 may receive a second DCI message during a same monitoring occasion as the DCI message (e.g., during a same set of time resources), and the second DCI message may schedule a second set of multiple downlink messages that includes at least a fourth downlink message via the first cell, the second cell, or a third cell (e.g., the third cell may be different than the first cell and the second cell or may be the same as at least one of the first cell or the second cell).

At 610, in some examples, the UE 115 may receive an indication of a quantity of cells that have scheduled shared channel communications with the UE 115, which may be output by the network entity 105. In some examples, an association between each bit of the field (e.g., of the DCI message) and a respective shared channel communication may be based on the quantity of cells. In some examples, the UE 115 may receive the indication of the quantity of bits associated with the field, an indication of a set of multiple quantities of bits that are each associated with respective shared channel communications.

At 615, the UE 115, the network entity 105, or both may communicate (e.g., the UE 115 may transmit a PUSCH message or receive a PDSCH message, the network entity 105 may transmit a PDSCH or receive PUSCH) the first shared channel communication via the first cell in accordance with one or more first bits (e.g., bits 331-a) of the field associated with the first cell. Additionally, or alternatively, the UE 115 may communicate the second shared channel communication via the second cell in accordance with one or more second bits (e.g., bits 331-b) of the field associated with the second cell. Additionally, or alternatively, the UE 115 may communicate the third shared channel communication via the first cell in accordance with one or more third bits (e.g., bits 331-c) of the field associated with the first cell.

At 620, in some examples, the UE 115 may generate one or more bits (e.g., HARQ-ACK bits, NACK bits) for one or more feedback messages (e.g., one or more feedback messages 320). For example, the UE 115 may generate one or more first bits for a first feedback message in accordance with a set of time domain resource allocations (e.g., in accordance with a row of a TDRA table, based on a Type-1 codebook generation). In some examples, the set of time domain resource allocations may include one or more entries that are associated with each downlink message (e.g., a shared channel communication) of the set of multiple downlink messages across the set of multiple cells. Additionally, or alternatively, the UE 115 may generate one or more bits for the first feedback message in accordance with a sub-codebook (e.g., a second sub-codebook) of a set of multiple sub-codebooks that is associated with the set of multiple downlink messages across the set of multiple cells (e.g., in accordance with a Type-2 codebook generation).

Additionally, or alternatively, the UE 115 may generate one or more bundled bits for the first feedback message (e.g., based on a binary AND operation). The one or more bundled bits may include feedback information associated with a first transport block of the first downlink message and at least a second transport block of the first downlink message (e.g., bits associated with different TBs), or associated with the first downlink message and at least a fourth downlink message different than the first downlink message (e.g., associated with different PDSCH messages), or both. In some examples, the UE 115 may transmit the first feedback message based on the generation of the one or more bits in accordance with the various examples described herein.

At 625, the UE 115 may transmit one or more feedback messages (e.g., a feedback message 320), which may correspond to one or more shared channel communications and may be obtained (e.g., received) by the network entity 105. For example, the UE 115 may transmit a first feedback message associated with the first downlink message in accordance with an offset (e.g., an offset 505) from the last symbol (e.g., the last symbol 515-a) of the third downlink message based on reception of the DCI message that scheduled the set of multiple downlink messages across a set of multiple cells that includes the first cell and the second cell. In some examples, at least one cell of the scheduled cells may have multiple scheduled downlink messages. In some examples,

In some examples, the UE 115 may transmit a second feedback message associated with the fourth downlink message (e.g., scheduled by a second DCI message). In some examples, the first feedback message may be transmitted prior to the second feedback message based on the DCI message and the second DCI message (e.g., an ordering associated with the DCI messages). For example, the first feedback message may be transmitted prior to the second feedback message based on an order of the DCI message and the second DCI message, where the order may be based on various parameters of each DCI message such as an aggregation level, a search space index, a CORESET index, a CCE index, or any combination thereof. Additionally, or alternatively, the first feedback message may be transmitted prior to the second feedback message based on a first reception start time of the first downlink message occurring prior to a second reception start time of the fourth downlink message.

In some examples, the set of multiple downlink messages (e.g., scheduled by the first DCI message) may include a fifth downlink message that has a last symbol (e.g., a last symbol 515-a of a first PDSCH) that occurs at a same time as the last symbol of the third downlink message (e.g., a last symbol 515-a of some other PDSCH) in the time domain (e.g., there may be more than one PDCSH message received last by the UE 15). In such examples, the third downlink message may be associated with a first processing time that is greater than a second processing time associated with the fifth downlink message, and the first feedback message may be transmitted based on the first processing time that is greater (e.g., based on the first processing time being greater) than the second processing time. Additionally, or alternatively, the first downlink message may be associated with a first processing time that terminates prior to the offset (e.g., prior to an uplink symbol in a PUCCH message used for transmitting feedback) and the second downlink message may be associated with a second processing time that terminates after the offset. In some examples, the UE 115 may transmit, via the first feedback message, one or more ACK bits based on the first processing time, and may transmit via a second feedback message associated with the second downlink message, one or more NACK bits based on the second processing time. Additionally, or alternatively, at least one downlink message of the set of multiple downlink messages may be associated with a processing time that terminates after the offset, and the UE 115 may transmit, via at least the first feedback message, one or more NACK bits (e.g., for each downlink message of the set of multiple scheduled downlink messages) based on the processing time of the at least one downlink message.

Additionally, or alternatively, the UE 115 may receive a second DCI message that schedules a second set of multiple downlink messages that includes at least a fourth downlink message via the first cell, a fifth downlink message via the second cell, and a sixth downlink message via the first cell, and at least one downlink message of the second set of multiple downlink messages may be associated with a processing time that terminates after a second offset from a last symbol of the second set of multiple downlink messages. In such examples, the UE 115 may refrain transmitting a feedback message (e.g., may ignore the scheduling DCI) associated with the fourth downlink message, the fifth downlink message, and the sixth downlink message based on the processing time of the at least one downlink message.

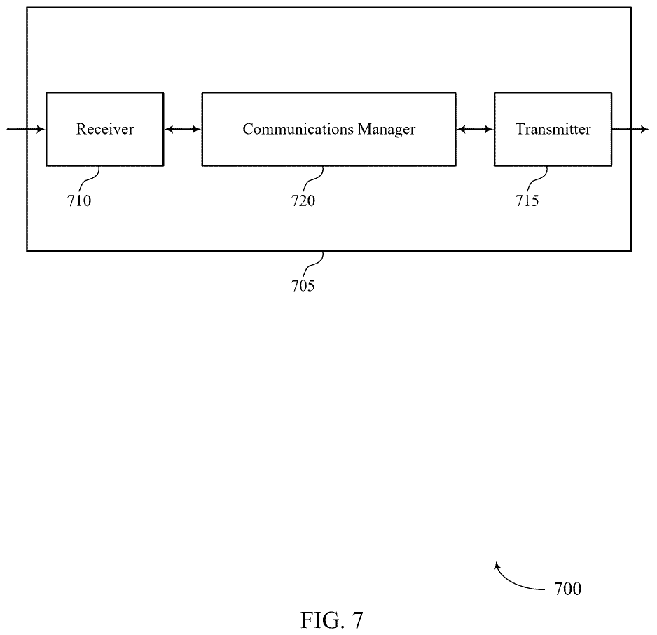

FIG. 7 shows a block diagram 700 of a device 705 that supports multi-cell and multi-shared channel communications in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to multi-cell and multi-shared channel communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to multi-cell and multi-shared channel communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of multi-cell and multi-shared channel communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The communications manager 720 is capable of, configured to, or operable to support a means for communicating the first shared channel communication via the first cell in accordance with one or more first bits of the field associated with the first cell. The communications manager 720 is capable of, configured to, or operable to support a means for communicating the second shared channel communication via the second cell in accordance with one or more second bits of the field associated with the second cell. The communications manager 720 is capable of, configured to, or operable to support a means for communicating the third shared channel communication via the first cell in accordance with one or more third bits of the field associated with the first cell.

Additionally, or alternatively, the communications manager 720 may support wireless communications in accordance with examples as disclosed herein. For example, the communications manager 720 is capable of, configured to, or operable to support a means for receiving a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The communications manager 720 is capable of, configured to, or operable to support a means for transmitting a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

The communications manager 720 may be an example of means for performing various aspects of multi-cell and multi-shared channel communications as described herein. The communications manager 720, or its sub-components, may be implemented in hardware (e.g., in communications management circuitry). The circuitry may comprise of processor, a DSP, an ASIC, an FPGA or other programmable logic device, discrete gate or transistor logic, discrete hardware components, or any combination thereof designed to perform the functions described in the present disclosure.

In another implementation, the communications manager 720, or its sub-components, may be implemented in code (e.g., as communications management software or firmware) executed by a processor, or any combination thereof. If implemented in code executed by a processor, the functions of the communications manager 720, or its sub-components may be executed by a general-purpose processor, a DSP, an ASIC, an FPGA or other programmable logic device.

In some examples, the communications manager 720 may be configured to perform various operations (e.g., receiving, determining, transmitting) using or otherwise in cooperation with the receiver 710, the transmitter 715, or both.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

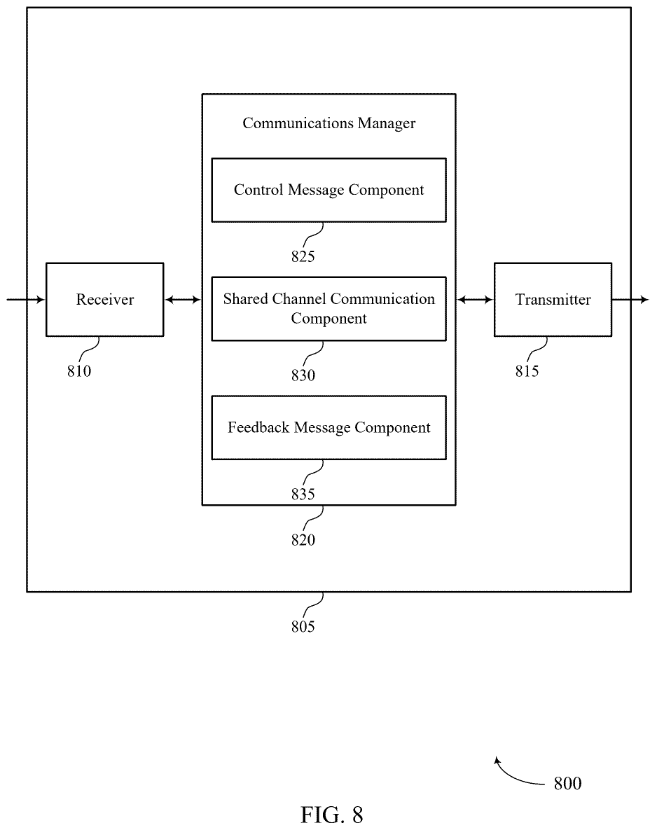

FIG. 8 shows a block diagram 800 of a device 805 that supports multi-cell and multi-shared channel communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to multi-cell and multi-shared channel communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to multi-cell and multi-shared channel communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of multi-cell and multi-shared channel communications as described herein. For example, the communications manager 820 may include a control message component 825, a shared channel communication component 830, a feedback message component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The control message component 825 is capable of, configured to, or operable to support a means for receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The shared channel communication component 830 is capable of, configured to, or operable to support a means for communicating the first shared channel communication via the first cell in accordance with one or more first bits of the field associated with the first cell. The shared channel communication component 830 is capable of, configured to, or operable to support a means for communicating the second shared channel communication via the second cell in accordance with one or more second bits of the field associated with the second cell. The shared channel communication component 830 is capable of, configured to, or operable to support a means for communicating the third shared channel communication via the first cell in accordance with one or more third bits of the field associated with the first cell.

Additionally, or alternatively, the communications manager 820 may support wireless communications in accordance with examples as disclosed herein. The control message component 825 is capable of, configured to, or operable to support a means for receiving a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The feedback message component 835 is capable of, configured to, or operable to support a means for transmitting a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

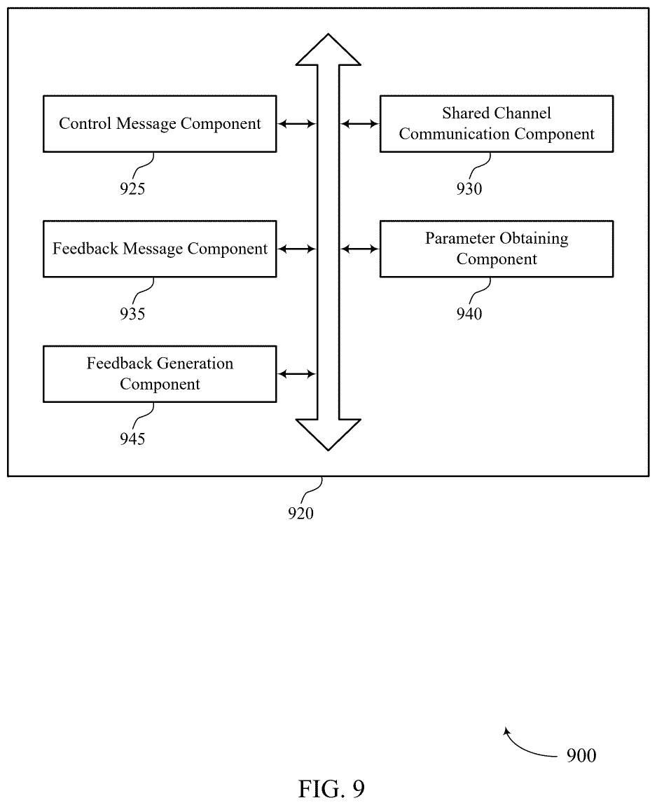

FIG. 9 shows a block diagram 900 of a communications manager 920 that supports multi-cell and multi-shared channel communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of multi-cell and multi-shared channel communications as described herein. For example, the communications manager 920 may include a control message component 925, a shared channel communication component 930, a feedback message component 935, a parameter obtaining component 940, a feedback generation component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The control message component 925 is capable of, configured to, or operable to support a means for receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The shared channel communication component 930 is capable of, configured to, or operable to support a means for communicating the first shared channel communication via the first cell in accordance with one or more first bits of the field associated with the first cell. In some examples, the shared channel communication component 930 is capable of, configured to, or operable to support a means for communicating the second shared channel communication via the second cell in accordance with one or more second bits of the field associated with the second cell. In some examples, the shared channel communication component 930 is capable of, configured to, or operable to support a means for communicating the third shared channel communication via the first cell in accordance with one or more third bits of the field associated with the first cell.

In some examples, the field includes a new data indicator field. In some examples, the maximum quantity of bits is selected for the new data indicator field based on the maximum quantity of scheduled shared channel communications.

In some examples, the parameter obtaining component 940 is capable of, configured to, or operable to support a means for receiving an indication of a quantity of cells that have scheduled shared channel communications with the UE, where an association between each bit of the field and a respective shared channel communication is based on the quantity of cells.

In some examples, the field includes a redundancy version field, and the parameter obtaining component 940 is capable of, configured to, or operable to support a means for receiving an indication of a quantity of bits associated with the field, where the maximum quantity of bits is selected for the field based on the maximum quantity of scheduled shared channel communications and on the quantity of bits.

In some examples, the redundancy version field includes a set of multiple blocks of bits. In some examples, each block of bits of the set of multiple blocks of bits is associated with a respective shared channel communication and has a respective quantity of bits corresponding to the quantity of bits.

In some examples, the redundancy version field includes a set of multiple blocks of bits. In some examples, each block of bits of the set of multiple blocks of bits is associated with a respective shared channel communication and has a respective quantity of bits. In some examples, the indication of the quantity of bits includes each respective quantity of bits for each shared channel communication of each cell.

In some examples, the control message component 925 is capable of, configured to, or operable to support a means for receiving, via the downlink control information message, a second field applicable to the first shared channel communication, the second shared channel communication, and the third shared channel communication, where the second field includes information associated with frequency domain resource allocation, a modulation and coding scheme, or both.

In some examples, the second field indicates a first frequency domain resource allocation, a first modulation and coding scheme, or both for the first shared channel communication and the third shared channel communication. In some examples, the second field indicates a second frequency domain resource allocation, a second modulation and coding scheme, or both for the second shared channel communication.

In some examples, the control message component 925 is capable of, configured to, or operable to support a means for receiving, via the downlink control information message, a second field applicable to the first shared channel communication, the second shared channel communication, and the third shared channel communication, where the second field includes information that indicates a first hybrid automatic repeat request process number for the first shared channel communication and the third shared channel communication, and indicates a second hybrid automatic repeat request process number for the second shared channel communication.

Additionally, or alternatively, the communications manager 920 may support wireless communications in accordance with examples as disclosed herein. In some examples, the control message component 925 is capable of, configured to, or operable to support a means for receiving a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The feedback message component 935 is capable of, configured to, or operable to support a means for transmitting a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

In some examples, the feedback message component 935 is capable of, configured to, or operable to support a means for generating one or more bits for the first feedback message in accordance with a set of time domain resource allocations, where the set of time domain resource allocations includes one or more entries that are associated with each downlink message of the set of multiple downlink messages across the set of multiple cells, and where transmitting the first feedback message is based on the generation of the one or more bits.

In some examples, the feedback generation component 945 is capable of, configured to, or operable to support a means for generating one or more bits for the first feedback message in accordance with a sub-codebook of a set of multiple sub-codebooks that is associated with the set of multiple downlink messages across the set of multiple cells, where transmitting the first feedback message is based on the generation of the one or more bits.

In some examples, the control message component 925 is capable of, configured to, or operable to support a means for receiving a second downlink control information message during a same monitoring occasion as the downlink control information message, where the second downlink control information message schedules a second set of multiple downlink messages that includes at least a fourth downlink message via the first cell, the second cell, or a third cell. In some examples, the feedback message component 935 is capable of, configured to, or operable to support a means for transmitting a second feedback message associated with the fourth downlink message, where the first feedback message is transmitted prior to the second feedback message based on the downlink control information message and the second downlink control information message.

In some examples, the first feedback message is transmitted prior to the second feedback message based on an order of the downlink control information message and the second downlink control information message. In some examples, the order is based on an aggregation level, a search space index, a control resource set index, a control channel element index, or any combination thereof.

In some examples, the first feedback message is transmitted prior to the second feedback message based on a first reception start time of the first downlink message occurring prior to a second reception start time of the fourth downlink message.

In some examples, the feedback generation component 945 is capable of, configured to, or operable to support a means for generating one or more bundled bits for the first feedback message, where the one or more bundled bits include feedback information associated with a first transport block of the first downlink message and at least a second transport block of the first downlink message, or associated with the first downlink message and at least a fourth downlink message different than the first downlink message, or both.

In some examples, the set of multiple downlink messages includes a fourth downlink message that has a last symbol that occurs at a same time as the last symbol of the third downlink message in the time domain. In some examples, the third downlink message is associated with a first processing time that is greater than a second processing time associated with the fourth downlink message. In some examples, the first feedback message is transmitted based on the first processing time that is greater than the second processing time.

In some examples, the first downlink message is associated with a first processing time that terminates prior to the offset and the second downlink message is associated with a second processing time that terminates after the offset, and the feedback message component 935 is capable of, configured to, or operable to support a means for transmitting, via the first feedback message, one or more ACK bits based on the first processing time. In some examples, the first downlink message is associated with a first processing time that terminates prior to the offset and the second downlink message is associated with a second processing time that terminates after the offset, and the feedback message component 935 is capable of, configured to, or operable to support a means for transmitting, via a second feedback message associated with the second downlink message, one or more NACK bits based on the second processing time.

In some examples, at least one downlink message of the plurality of downlink messages is associated with a processing time that terminates after the offset, and the feedback message component 935 is capable of, configured to, or operable to support a means for transmitting, via at least the first feedback message, one or more NACK bits based on the processing time of the at least one downlink message.

In some examples, the control message component 925 is capable of, configured to, or operable to support a means for receiving a second downlink control information message that schedules a second set of multiple downlink messages that includes at least a fourth downlink message via the first cell, a fifth downlink message via the second cell, and a sixth downlink message via the first cell, where at least one downlink message of the second set of multiple downlink messages is associated with a processing time that terminates after a second offset from a last symbol of the second set of multiple downlink messages. In some examples, the feedback message component 935 is capable of, configured to, or operable to support a means for refraining from transmitting a feedback message associated with the fourth downlink message, the fifth downlink message, and the sixth downlink message based on the processing time of the at least one downlink message.

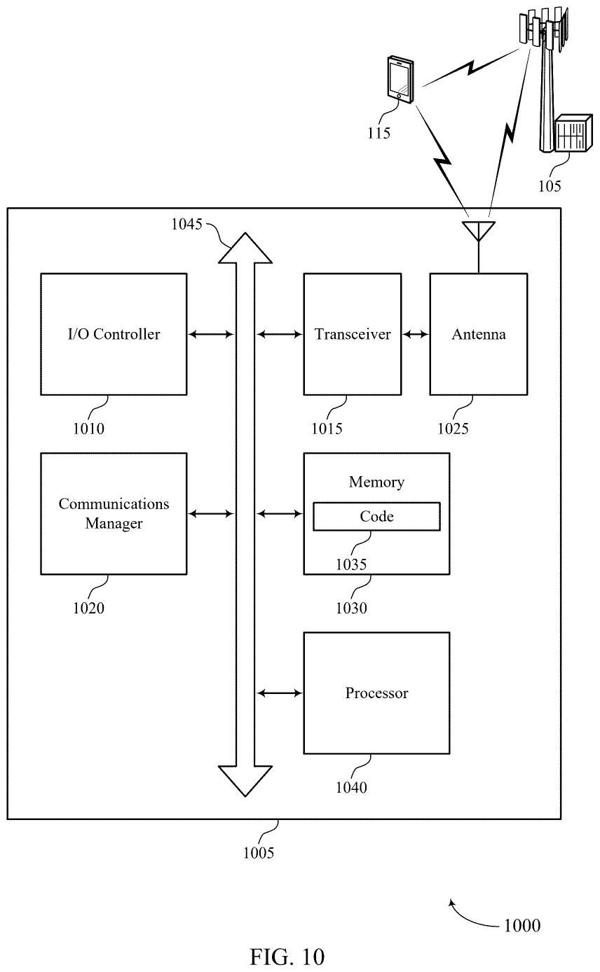

FIG. 10 shows a diagram of a system 1000 including a device 1005 that supports multi-cell and multi-shared channel communications in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting multi-cell and multi-shared channel communications). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The communications manager 1020 is capable of, configured to, or operable to support a means for communicating the first shared channel communication via the first cell in accordance with one or more first bits of the field associated with the first cell. The communications manager 1020 is capable of, configured to, or operable to support a means for communicating the second shared channel communication via the second cell in accordance with one or more second bits of the field associated with the second cell. The communications manager 1020 is capable of, configured to, or operable to support a means for communicating the third shared channel communication via the first cell in accordance with one or more third bits of the field associated with the first cell.

Additionally, or alternatively, the communications manager 1020 may support wireless communications in accordance with examples as disclosed herein. For example, the communications manager 1020 is capable of, configured to, or operable to support a means for receiving a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The communications manager 1020 is capable of, configured to, or operable to support a means for transmitting a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

By including or configuring the communications manager 1020 in accordance with examples as described herein, the device 1005 may support techniques for improved communication reliability, reduced latency, reduced power consumption, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of multi-cell and multi-shared channel communications as described herein, or the at least one processor 1040 and the at least one memory 1030 may be otherwise configured to, individually or collectively, perform or support such operations.

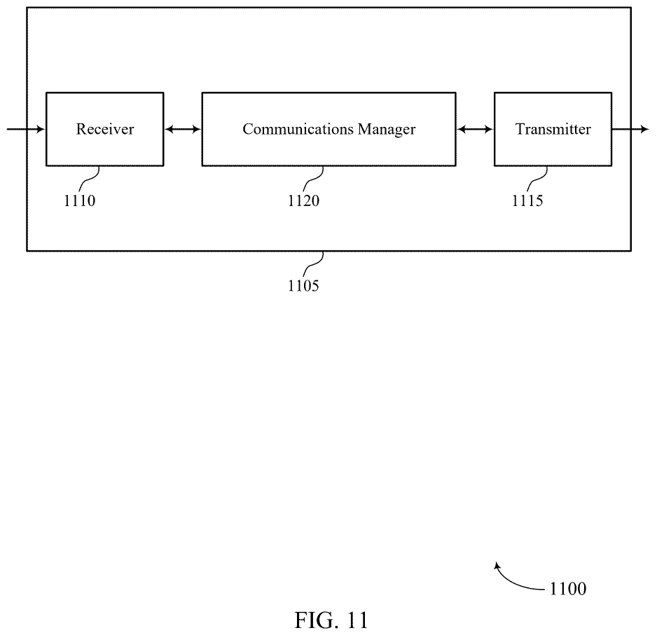

FIG. 11 shows a block diagram 1100 of a device 1105 that supports multi-cell and multi-shared channel communications in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of multi-cell and multi-shared channel communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The communications manager 1120 is capable of, configured to, or operable to support a means for communicating the first shared channel communication via the first cell in accordance with one or more first bits of the field associated with the first cell. The communications manager 1120 is capable of, configured to, or operable to support a means for communicating the second shared channel communication via the second cell in accordance with one or more second bits of the field associated with the second cell. The communications manager 1120 is capable of, configured to, or operable to support a means for communicating the third shared channel communication via the first cell in accordance with one or more third bits of the field associated with the first cell.

Additionally, or alternatively, the communications manager 1120 may support wireless communications in accordance with examples as disclosed herein. For example, the communications manager 1120 is capable of, configured to, or operable to support a means for outputting a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The communications manager 1120 is capable of, configured to, or operable to support a means for obtaining a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

The communications manager 1120 may be an example of means for performing various aspects of managing smart repeaters as described herein. The communications manager 1120, or its sub-components, may be implemented in hardware (e.g., in communications management circuitry). The circuitry may comprise of processor, DSP, an ASIC, an FPGA or other programmable logic device, discrete gate or transistor logic, discrete hardware components, or any combination thereof designed to perform the functions described in the present disclosure.

In another implementation, the communications manager 1120, or its sub-components, may be implemented in code (e.g., as communications management software or firmware) executed by a processor, or any combination thereof. If implemented in code executed by a processor, the functions of the communications manager 1120, or its sub-components may be executed by a general-purpose processor, a DSP, an ASIC, an FPGA or other programmable logic device.

In some examples, the communications manager 1120 may be configured to perform various operations (e.g., receiving, determining, transmitting) using or otherwise in cooperation with the receiver 1110, the transmitter 1115, or both.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources.

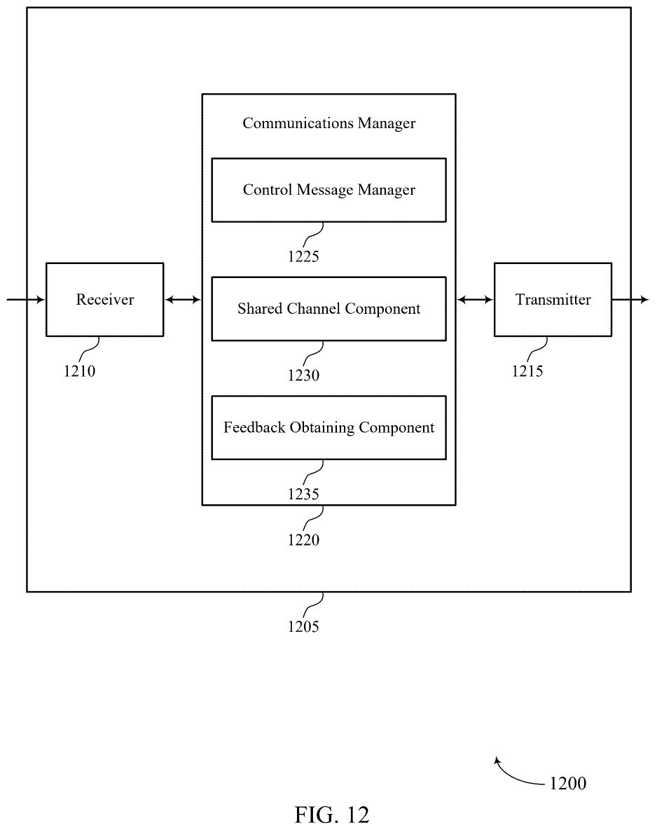

FIG. 12 shows a block diagram 1200 of a device 1205 that supports multi-cell and multi-shared channel communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of multi-cell and multi-shared channel communications as described herein. For example, the communications manager 1220 may include a control message manager 1225, a shared channel component 1230, a feedback obtaining component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The control message manager 1225 is capable of, configured to, or operable to support a means for outputting a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The shared channel component 1230 is capable of, configured to, or operable to support a means for communicating the first shared channel communication via the first cell in accordance with one or more first bits of the field associated with the first cell. The shared channel component 1230 is capable of, configured to, or operable to support a means for communicating the second shared channel communication via the second cell in accordance with one or more second bits of the field associated with the second cell. The shared channel component 1230 is capable of, configured to, or operable to support a means for communicating the third shared channel communication via the first cell in accordance with one or more third bits of the field associated with the first cell.

Additionally, or alternatively, the communications manager 1220 may support wireless communications in accordance with examples as disclosed herein. The control message manager 1225 is capable of, configured to, or operable to support a means for outputting a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The feedback obtaining component 1235 is capable of, configured to, or operable to support a means for obtaining a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

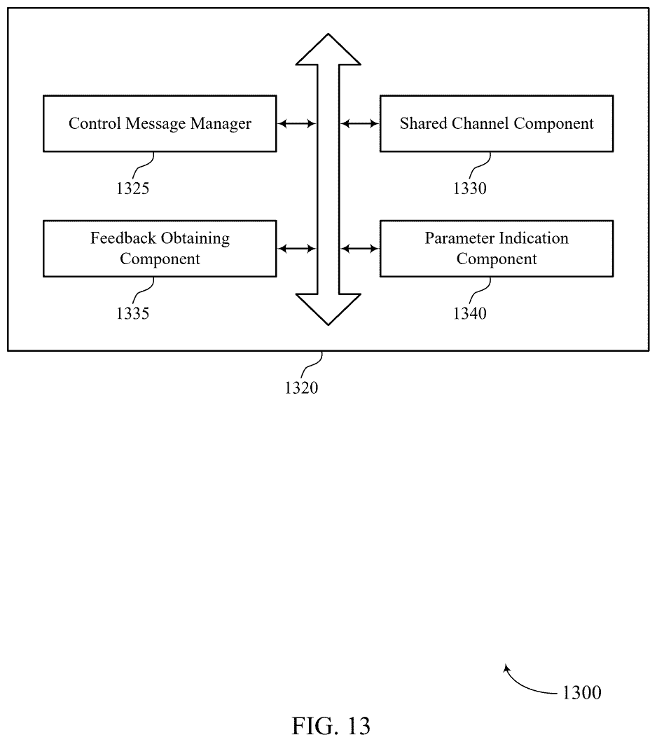

FIG. 13 shows a block diagram 1300 of a communications manager 1320 that supports multi-cell and multi-shared channel communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of multi-cell and multi-shared channel communications as described herein. For example, the communications manager 1320 may include a control message manager 1325, a shared channel component 1330, a feedback obtaining component 1335, a parameter indication component 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The control message manager 1325 is capable of, configured to, or operable to support a means for outputting a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The shared channel component 1330 is capable of, configured to, or operable to support a means for communicating the first shared channel communication via the first cell in accordance with one or more first bits of the field associated with the first cell. In some examples, the shared channel component 1330 is capable of, configured to, or operable to support a means for communicating the second shared channel communication via the second cell in accordance with one or more second bits of the field associated with the second cell. In some examples, the shared channel component 1330 is capable of, configured to, or operable to support a means for communicating the third shared channel communication via the first cell in accordance with one or more third bits of the field associated with the first cell.

In some examples, the field includes a new data indicator field. In some examples, the maximum quantity of bits is selected for the new data indicator field based on the maximum quantity of scheduled shared channel communications.

In some examples, the parameter indication component 1340 is capable of, configured to, or operable to support a means for outputting an indication of a quantity of cells that have scheduled shared channel communications, where an association between each bit of the field and a respective shared channel communication is based on the quantity of cells.

In some examples, the field includes a redundancy version field, and the parameter indication component 1340 is capable of, configured to, or operable to support a means for outputting an indication of a quantity of bits associated with the field, where the maximum quantity of bits is selected for the field based on the maximum quantity of scheduled shared channel communications and on the quantity of bits.

In some examples, the redundancy version field includes a set of multiple blocks of bits. In some examples, each block of bits of the set of multiple blocks of bits is associated with a respective shared channel communication and has a respective quantity of bits corresponding to the quantity of bits.

In some examples, the redundancy version field includes a set of multiple blocks of bits. In some examples, each block of bits of the set of multiple blocks of bits is associated with a respective shared channel communication and has a respective quantity of bits. In some examples, the indication of the quantity of bits includes each respective quantity of bits for each shared channel communication of each cell.

In some examples, the control message manager 1325 is capable of, configured to, or operable to support a means for outputting, via the downlink control information message, a second field applicable to the first shared channel communication, the second shared channel communication, and the third shared channel communication, where the second field includes information associated with frequency domain resource allocation, a modulation and coding scheme, or both.

In some examples, the second field indicates a first frequency domain resource allocation, a first modulation and coding scheme, or both for the first shared channel communication and the third shared channel communication. In some examples, the second field indicates a second frequency domain resource allocation, a second modulation and coding scheme, or both for the second shared channel communication.

In some examples, the control message manager 1325 is capable of, configured to, or operable to support a means for outputting, via the downlink control information message, a second field applicable to the first shared channel communication, the second shared channel communication, and the third shared channel communication, where the second field includes information that indicates a first hybrid automatic repeat request process number for the first shared channel communication and the third shared channel communication, and indicates a second hybrid automatic repeat request process number for the second shared channel communication.

Additionally, or alternatively, the communications manager 1320 may support wireless communications in accordance with examples as disclosed herein. In some examples, the control message manager 1325 is capable of, configured to, or operable to support a means for outputting a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The feedback obtaining component 1335 is capable of, configured to, or operable to support a means for obtaining a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

In some examples, one or more bits of the first feedback message are obtained in accordance with a set of time domain resource allocations. In some examples, the set of time domain resource allocations includes one or more entries that are associated with each downlink message of the set of multiple downlink messages across the set of multiple cells.

In some examples, one or more bits of the first feedback message are obtained in accordance with a sub-codebook of a set of multiple sub-codebooks that is associated with the set of multiple downlink messages across the set of multiple cells.

In some examples, the control message manager 1325 is capable of, configured to, or operable to support a means for outputting a second downlink control information message during a same monitoring occasion as the downlink control information message, where the second downlink control information message schedules a second set of multiple downlink messages that includes at least a fourth downlink message via the first cell, the second cell, or a third cell. In some examples, the feedback obtaining component 1335 is capable of, configured to, or operable to support a means for obtaining a second feedback message associated with the fourth downlink message, where the first feedback message is obtained prior to the second feedback message based on the downlink control information message and the second downlink control information message.

In some examples, the first feedback message is obtained prior to the second feedback message based on an order of the downlink control information message and the second downlink control information message. In some examples, the order is based on an aggregation level, a search space index, a control resource set index, a control channel element index, or any combination thereof.

In some examples, the first feedback message is transmitted prior to the second feedback message based on a first reception start time of the first downlink message occurring prior to a second reception start time of the fourth downlink message.

In some examples, the first feedback message includes one or more bundled bits that include feedback information associated with a first transport block of the first downlink message and at least a second transport block of the first downlink message, or associated with the first downlink message and at least a fourth downlink message different than the first downlink message, or both.

In some examples, the set of multiple downlink messages includes a fourth downlink message that has a last symbol that occurs at a same time as the last symbol of the third downlink message in the time domain. In some examples, the third downlink message is associated with a first processing time that is greater than a second processing time associated with the fourth downlink message. In some examples, the first feedback message is obtained based on the first processing time that is greater than the second processing time.

In some examples, the first downlink message is associated with a first processing time that terminates prior to the offset and the second downlink message is associated with a second processing time that terminates after the offset, and the feedback obtaining component 1335 is capable of, configured to, or operable to support a means for obtaining, via the first feedback message, one or more ACK bits based on the first processing time. In some examples, the first downlink message is associated with a first processing time that terminates prior to the offset and the second downlink message is associated with a second processing time that terminates after the offset, and the feedback obtaining component 1335 is capable of, configured to, or operable to support a means for obtaining, via a second feedback message associated with the second downlink message, one or more NACK bits based on the second processing time.

In some examples, at least one downlink message of the plurality of downlink messages is associated with a processing time that terminates after the offset, and the feedback obtaining component 1335 is capable of, configured to, or operable to support a means for obtaining, via at least the first feedback message, one or more NACK bits based on the processing time of the at least one downlink message.

In some examples, the control message manager 1325 is capable of, configured to, or operable to support a means for outputting a second downlink control information message that schedules a second set of multiple downlink messages that includes at least a fourth downlink message via the first cell, a fifth downlink message via the second cell, and a sixth downlink message via the first cell, where at least one downlink message of the second set of multiple downlink messages is associated with a processing time that terminates after a second offset from a last symbol of the second set of multiple downlink messages. In some examples, the feedback obtaining component 1335 is capable of, configured to, or operable to support a means for refraining from obtaining a feedback message associated with the fourth downlink message, the fifth downlink message, and the sixth downlink message based on the processing time of the at least one downlink message.

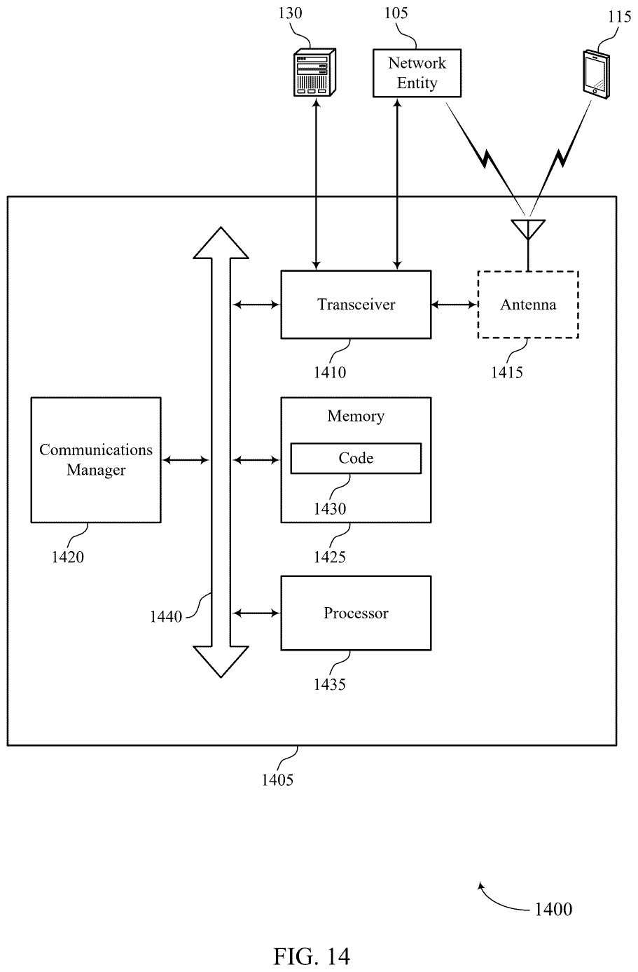

FIG. 14 shows a diagram of a system 1400 including a device 1405 that supports multi-cell and multi-shared channel communications in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting multi-cell and multi-shared channel communications). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The communications manager 1420 is capable of, configured to, or operable to support a means for communicating the first shared channel communication via the first cell in accordance with one or more first bits of the field associated with the first cell. The communications manager 1420 is capable of, configured to, or operable to support a means for communicating the second shared channel communication via the second cell in accordance with one or more second bits of the field associated with the second cell. The communications manager 1420 is capable of, configured to, or operable to support a means for communicating the third shared channel communication via the first cell in accordance with one or more third bits of the field associated with the first cell.

Additionally, or alternatively, the communications manager 1420 may support wireless communications in accordance with examples as disclosed herein. For example, the communications manager 1420 is capable of, configured to, or operable to support a means for outputting a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The communications manager 1420 is capable of, configured to, or operable to support a means for obtaining a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages.

By including or configuring the communications manager 1420 in accordance with examples as described herein, the device 1405 may support techniques for improved communication reliability, reduced latency, improved user experience related to reduced processing, reduced power consumption, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of multi-cell and multi-shared channel communications as described herein, or the at least one processor 1435 and the at least one memory 1425 may be otherwise configured to, individually or collectively, perform or support such operations.

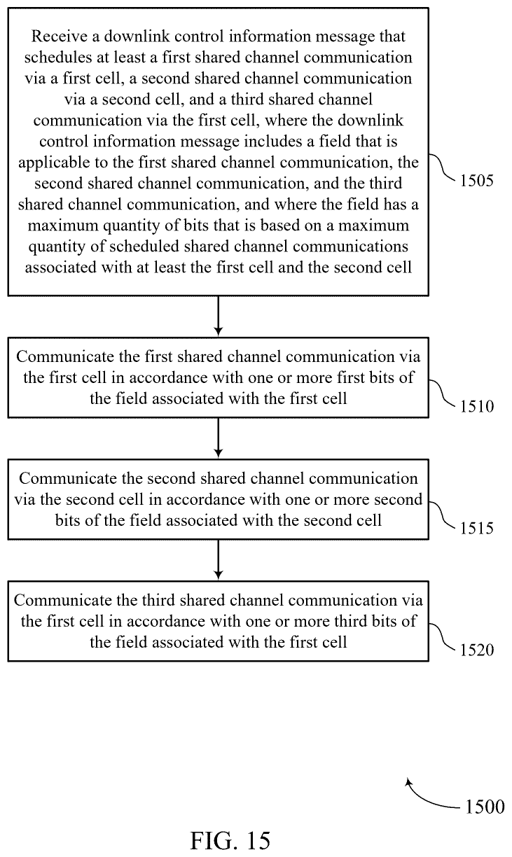

FIG. 15 shows a flowchart illustrating a method 1500 that supports multi-cell and multi-shared channel communications in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The operations of 1505 may be performed in accordance with examples as disclosed herein. In some examples, aspects of the operations of 1505 may be performed by a control message component 925 as described with reference to FIG. 9.

At 1510, the method may include communicating the first shared channel communication via the first cell in accordance with one or more first bits of the field associated with the first cell. The operations of 1510 may be performed in accordance with examples as disclosed herein. In some examples, aspects of the operations of 1510 may be performed by a shared channel communication component 930 as described with reference to FIG. 9.

At 1515, the method may include communicating the second shared channel communication via the second cell in accordance with one or more second bits of the field associated with the second cell. The operations of 1515 may be performed in accordance with examples as disclosed herein. In some examples, aspects of the operations of 1515 may be performed by a shared channel communication component 930 as described with reference to FIG. 9.

At 1520, the method may include communicating the third shared channel communication via the first cell in accordance with one or more third bits of the field associated with the first cell. The operations of 1520 may be performed in accordance with examples as disclosed herein. In some examples, aspects of the operations of 1520 may be performed by a shared channel communication component 930 as described with reference to FIG. 9.

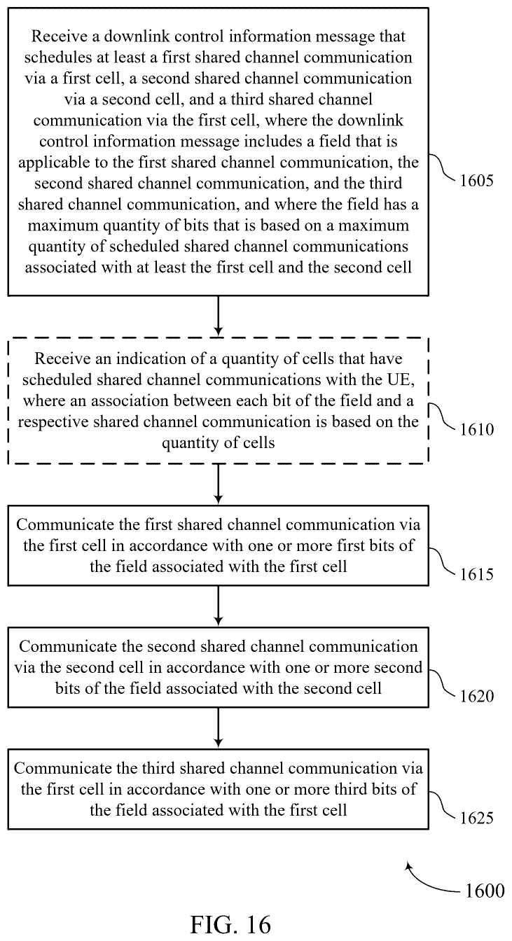

FIG. 16 shows a flowchart illustrating a method 1600 that supports multi-cell and multi-shared channel communications in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The operations of 1605 may be performed in accordance with examples as disclosed herein. In some examples, aspects of the operations of 1605 may be performed by a control message component 925 as described with reference to FIG. 9.

At 1610, in some examples, the method may include receiving an indication of a quantity of cells that have scheduled shared channel communications with the UE, where an association between each bit of the field and a respective shared channel communication is based on the quantity of cells. The operations of 1610 may be performed in accordance with examples as disclosed herein. In some examples, aspects of the operations of 1610 may be performed by a parameter obtaining component 940 as described with reference to FIG. 9.

At 1615, the method may include communicating the first shared channel communication via the first cell in accordance with one or more first bits of the field associated with the first cell. The operations of 1615 may be performed in accordance with examples as disclosed herein. In some examples, aspects of the operations of 1615 may be performed by a shared channel communication component 930 as described with reference to FIG. 9.

At 1620, the method may include communicating the second shared channel communication via the second cell in accordance with one or more second bits of the field associated with the second cell. The operations of 1620 may be performed in accordance with examples as disclosed herein. In some examples, aspects of the operations of 1620 may be performed by a shared channel communication component 930 as described with reference to FIG. 9.

At 1625, the method may include communicating the third shared channel communication via the first cell in accordance with one or more third bits of the field associated with the first cell. The operations of 1625 may be performed in accordance with examples as disclosed herein. In some examples, aspects of the operations of 1625 may be performed by a shared channel communication component 930 as described with reference to FIG. 9.

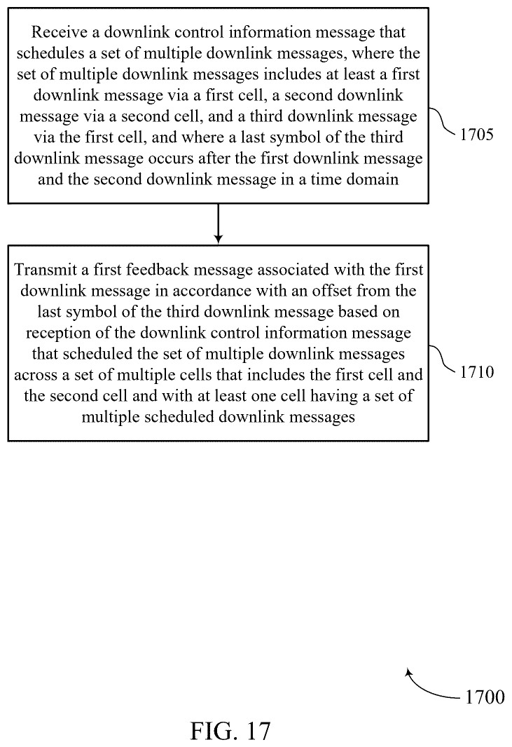

FIG. 17 shows a flowchart illustrating a method 1700 that supports multi-cell and multi-shared channel communications in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The operations of 1705 may be performed in accordance with examples as disclosed herein. In some examples, aspects of the operations of 1705 may be performed by a control message component 925 as described with reference to FIG. 9.

At 1710, the method may include transmitting a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages. The operations of 1710 may be performed in accordance with examples as disclosed herein. In some examples, aspects of the operations of 1710 may be performed by a feedback message component 935 as described with reference to FIG. 9.

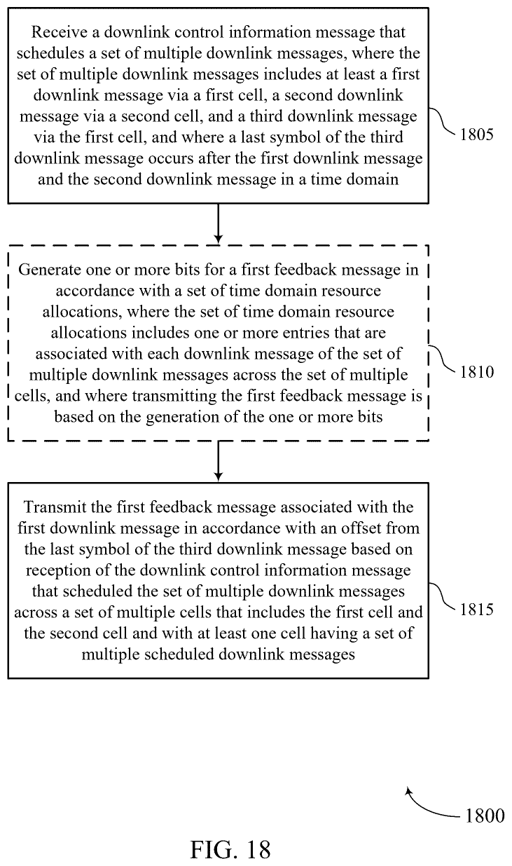

FIG. 18 shows a flowchart illustrating a method 1800 that supports multi-cell and multi-shared channel communications in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The operations of 1805 may be performed in accordance with examples as disclosed herein. In some examples, aspects of the operations of 1805 may be performed by a control message component 925 as described with reference to FIG. 9.

At 1810, in some examples, the method may include generating one or more bits for a first feedback message in accordance with a set of time domain resource allocations, where the set of time domain resource allocations includes one or more entries that are associated with each downlink message of the set of multiple downlink messages across the set of multiple cells, and where transmitting the first feedback message is based on the generation of the one or more bits. The operations of 1810 may be performed in accordance with examples as disclosed herein. In some examples, aspects of the operations of 1810 may be performed by a feedback message component 935 as described with reference to FIG. 9.

At 1815, the method may include transmitting the first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages. The operations of 1815 may be performed in accordance with examples as disclosed herein. In some examples, aspects of the operations of 1815 may be performed by a feedback message component 935 as described with reference to FIG. 9.

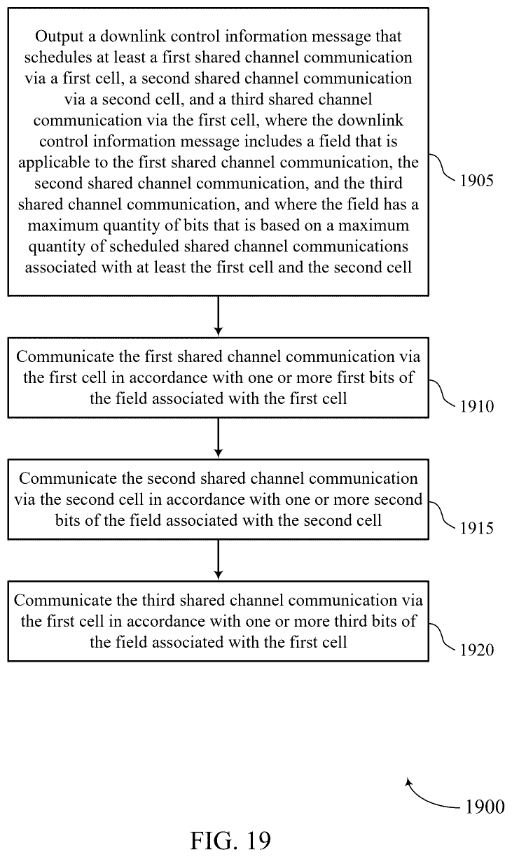

FIG. 19 shows a flowchart illustrating a method 1900 that supports multi-cell and multi-shared channel communications in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include outputting a downlink control information message that schedules at least a first shared channel communication via a first cell, a second shared channel communication via a second cell, and a third shared channel communication via the first cell, where the downlink control information message includes a field that is applicable to the first shared channel communication, the second shared channel communication, and the third shared channel communication, and where the field has a maximum quantity of bits that is based on a maximum quantity of scheduled shared channel communications associated with at least the first cell and the second cell. The operations of 1905 may be performed in accordance with examples as disclosed herein. In some examples, aspects of the operations of 1905 may be performed by a control message manager 1325 as described with reference to FIG. 13.

At 1910, the method may include communicating the first shared channel communication via the first cell in accordance with one or more first bits of the field associated with the first cell. The operations of 1910 may be performed in accordance with examples as disclosed herein. In some examples, aspects of the operations of 1910 may be performed by a shared channel component 1330 as described with reference to FIG. 13.

At 1915, the method may include communicating the second shared channel communication via the second cell in accordance with one or more second bits of the field associated with the second cell. The operations of 1915 may be performed in accordance with examples as disclosed herein. In some examples, aspects of the operations of 1915 may be performed by a shared channel component 1330 as described with reference to FIG. 13.

At 1920, the method may include communicating the third shared channel communication via the first cell in accordance with one or more third bits of the field associated with the first cell. The operations of 1920 may be performed in accordance with examples as disclosed herein. In some examples, aspects of the operations of 1920 may be performed by a shared channel component 1330 as described with reference to FIG. 13.

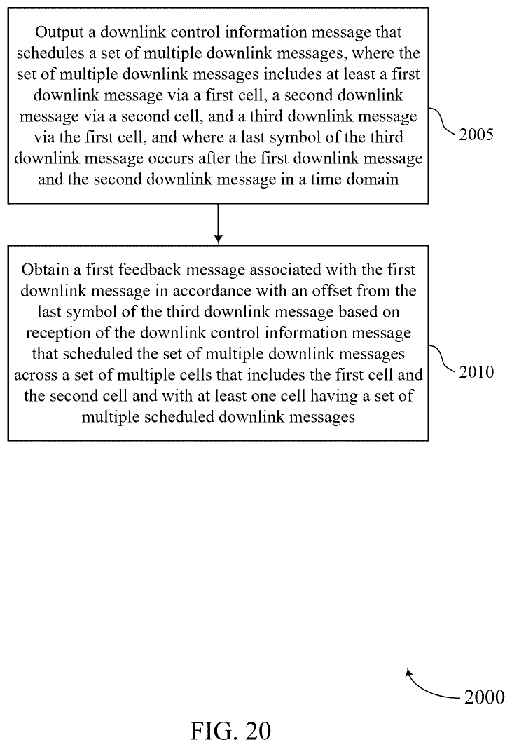

FIG. 20 shows a flowchart illustrating a method 2000 that supports multi-cell and multi-shared channel communications in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include outputting a downlink control information message that schedules a set of multiple downlink messages, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The operations of 2005 may be performed in accordance with examples as disclosed herein. In some examples, aspects of the operations of 2005 may be performed by a control message manager 1325 as described with reference to FIG. 13.

At 2010, the method may include obtaining a first feedback message associated with the first downlink message in accordance with an offset from the last symbol of the third downlink message based on reception of the downlink control information message that scheduled the set of multiple downlink messages across a set of multiple cells that includes the first cell and the second cell and with at least one cell having a set of multiple scheduled downlink messages. The operations of 2010 may be performed in accordance with examples as disclosed herein. In some examples, aspects of the operations of 2010 may be performed by a feedback obtaining component 1335 as described with reference to FIG. 13.

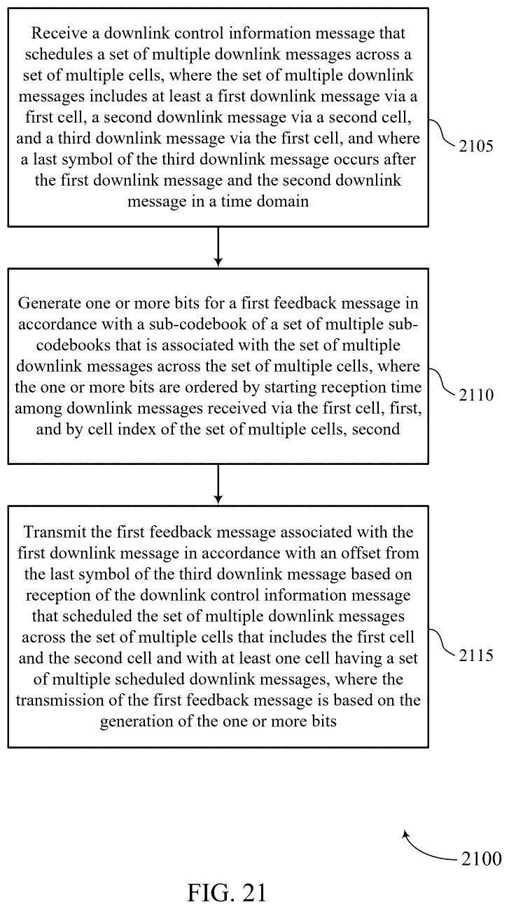

FIG. 21 shows an example of a method 2100 that supports multi-cell and multi-shared channel communications in accordance with one or more aspects of the present disclosure. The operations of the method 2100 may be implemented by a UE or its components as described herein. For example, the operations of the method 2100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 2105, the method may include receiving a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The operations of 2105 may be performed in accordance with examples as disclosed herein. In some examples, aspects of the operations of 2105 may be performed by a control message component 925 as described with reference to FIG. 9.

At 2110, the method may include generating one or more bits for a first feedback message in accordance with a sub-codebook of a set of multiple sub-codebooks that is associated with the set of multiple downlink messages across the set of multiple cells, where the one or more bits are ordered by starting reception time among downlink messages received via the first cell, first, and by cell index of the set of multiple cells, second. The operations of 2105 may be performed in accordance with examples as disclosed herein. In some examples, aspects of the operations of 2110 may be performed by a feedback generation component 945 as described with reference to FIG. 9.

At 2115, the method may include transmitting the first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the transmission of the first feedback message is based on the generation of the one or more bits. The operations of 2115 may be performed in accordance with examples as disclosed herein.

In some examples, aspects of the operations of 2105 may be performed by a feedback message component 935 as described with reference to FIG. 9.

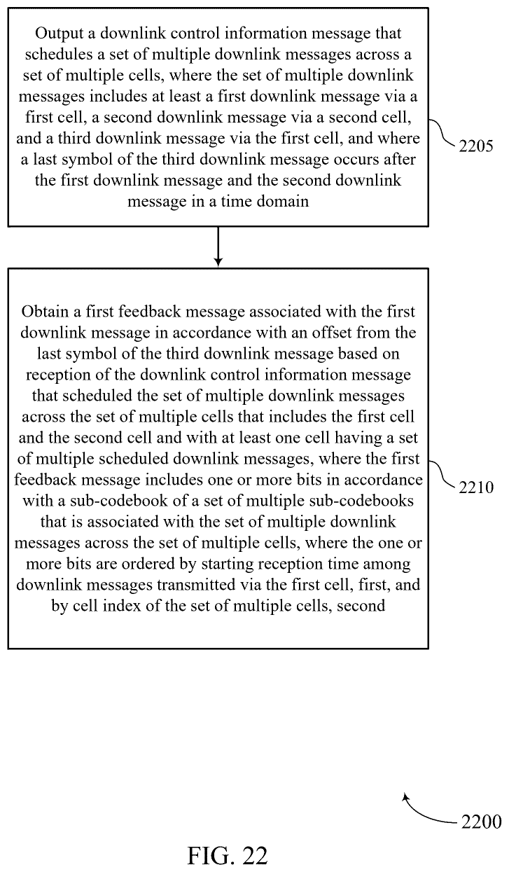

FIG. 22 shows an example of a method 2200 that supports multi-cell and multi-shared channel communications in accordance with one or more aspects of the present disclosure. The operations of the method 2200 may be implemented by a network entity or its components as described herein. For example, the operations of the method 2200 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2205, the method may include outputting a downlink control information message that schedules a set of multiple downlink messages across a set of multiple cells, where the set of multiple downlink messages includes at least a first downlink message via a first cell, a second downlink message via a second cell, and a third downlink message via the first cell, and where a last symbol of the third downlink message occurs after the first downlink message and the second downlink message in a time domain. The operations of 2205 may be performed in accordance with examples as disclosed herein. In some examples, aspects of the operations of 2205 may be performed by a control message manager 1325 as described with reference to FIG. 13.

At 2210, the method may include obtaining a first feedback message associated with the first downlink message in accordance with an offset from the last symbol of the third downlink message based on reception of the downlink control information message that scheduled the set of multiple downlink messages across the set of multiple cells that includes the first cell and the second cell and with at least one cell having a set of multiple scheduled downlink messages, where the first feedback message includes one or more bits in accordance with a sub-codebook of a set of multiple sub-codebooks that is associated with the set of multiple downlink messages across the set of multiple cells, where the one or more bits are ordered by starting reception time among downlink messages transmitted via the first cell, first, and by cell index of the set of multiple cells, second. The operations of 2210 may be performed in accordance with examples as disclosed herein. In some examples, aspects of the operations of 2210 may be performed by a feedback obtaining component 1335 as described with reference to FIG. 13.

The following provides an overview of aspects of the present disclosure:
Aspect 1: An apparatus for wireless communication at a UE, comprising: one or more memories; and one or more processors coupled with the one or more memories and configured to cause the UE to: receive a downlink control information message that schedules a plurality of downlink messages across a plurality of cells, wherein the plurality of downlink messages includes at least a first downlink message via a first cell, a second downlink message via a second cell, and a third downlink message via the first cell, and wherein a last symbol of the third downlink message occurs after the first downlink message and the second downlink message in a time domain; generate one or more bits for a first feedback message in accordance with a sub-codebook of a plurality of sub-codebooks that is associated with the plurality of downlink messages across the plurality of cells, wherein the one or more bits are ordered by starting reception time among downlink messages received via the first cell, first, and by cell index of the plurality of cells, second; and transmit the first feedback message associated with the first downlink message in accordance with an offset from the last symbol of the third downlink message based at least in part on reception of the downlink control information message that scheduled the plurality of downlink messages across the plurality of cells that includes the first cell and the second cell and with at least one cell having a plurality of scheduled downlink messages, wherein the transmission of the first feedback message is based at least in part on the generation of the one or more bits.
Aspect 2: The apparatus of aspect 1, wherein the first downlink message is associated with a first processing time that terminates prior to the offset and the second downlink message is associated with a second processing time that terminates after the offset, and the one or more processors are configured to cause the UE to: transmit, via the first feedback message, one or more acknowledgment (ACK) bits based at least in part on the first processing time; and transmit, via a second feedback message associated with the second downlink message, one or more not-acknowledgment (NACK) bits based at least in part on the second processing time.
Aspect 3: The apparatus of any of aspects 1 through 2, wherein at least one downlink message of the plurality of downlink messages is associated with a processing time that terminates after the offset, and the one or more processors are configured to cause the UE to: transmit, via at least the first feedback message, one or more not acknowledgment (NACK) bits based at least in part on the processing time of the at least one downlink message.
Aspect 4: The apparatus of any of aspects 1 through 3, wherein the one or more processors are configured to cause the UE to: receive a second downlink control information message that schedules a second plurality of downlink messages that includes at least a fourth downlink message via the first cell, a fifth downlink message via the second cell, and a sixth downlink message via the first cell, wherein at least one downlink message of the second plurality of downlink messages is associated with a processing time that terminates after a second offset from a last symbol of the second plurality of downlink messages; and refrain from transmission of a feedback message associated with the fourth downlink message, the fifth downlink message, and the sixth downlink message based at least in part on the processing time of the at least one downlink message.
Aspect 5: The apparatus of any of aspects 1 through 4, wherein the one or more processors are configured to cause the UE to: generate one or more bits for the first feedback message in accordance with a set of time domain resource allocations, wherein the set of time domain resource allocations includes one or more entries that are associated with each downlink message of the plurality of downlink messages across the plurality of cells, and wherein the transmission of the first feedback message is based at least in part on the generation of the one or more bits.
Aspect 6: The apparatus of any of aspects 1 through 5, wherein the one or more processors are configured to cause the UE to: receive, via an antenna array of the UE, a second downlink control information message within a same monitoring occasion as the downlink control information message, wherein the second downlink control information message schedules a second plurality of downlink messages that includes at least a fourth downlink message via the first cell, the second cell, or a third cell; and transmit a second feedback message associated with the fourth downlink message, wherein the first feedback message is transmitted prior to the second feedback message based at least in part on the downlink control information message and the second downlink control information message.
Aspect 7: The apparatus of aspect 6, wherein: the first feedback message is transmitted prior to the second feedback message based at least in part on an order of the downlink control information message and the second downlink control information message; and the order is based at least in part on an aggregation level, a search space index, a control resource set index, a control channel element index, or any combination thereof.
Aspect 8: The apparatus of any of aspects 6 through 7, wherein the first feedback message is transmitted prior to the second feedback message based at least in part on a first reception start time of the first downlink message that occurs prior to a second reception start time of the fourth downlink message.
Aspect 9: The apparatus of any of aspects 1 through 8, wherein: the plurality of downlink messages includes a fourth downlink message that has a last symbol that occurs at a same time as the last symbol of the third downlink message in the time domain, the third downlink message is associated with a first processing time that is greater than a second processing time associated with the fourth downlink message, and the first feedback message is transmitted based at least in part on the first processing time that is greater than the second processing time.
Aspect 10: An apparatus for wireless communication at a user equipment (UE), comprising: one or more memories; and one or more processors coupled with the one or more memories and configured to cause the UE to: receive a downlink control information message that schedules at least a first shared channel communication via a first cell, a second shared channel communication via a second cell, and a third shared channel communication via the first cell, wherein the downlink control information message includes a field that is applicable to the first shared channel communication, the second shared channel communication, and the third shared channel communication, and wherein the field has a maximum quantity of bits that is based at least in part on a maximum quantity of scheduled shared channel communications associated with at least the first cell and the second cell; communicate the first shared channel communication via the first cell in accordance with one or more first bits of the field associated with the first cell; communicate the second shared channel communication via the second cell in accordance with one or more second bits of the field associated with the second cell; and communicate the third shared channel communication via the first cell in accordance with one or more third bits of the field associated with the first cell.
Aspect 11: The apparatus of aspect 10, wherein: the field comprises a new data indicator field; and the maximum quantity of bits is selected for the new data indicator field based at least in part on the maximum quantity of scheduled shared channel communications.
Aspect 12: The apparatus of any of aspects 10 through 11, wherein the one or more processors are configured to cause the UE to: receive, via an antenna array of the UE, an indication of a quantity of cells that have scheduled shared channel communications with the UE, wherein an association between each bit of the field and a respective shared channel communication is based at least in part on the quantity of cells.
Aspect 13: The apparatus of any of aspects 10 through 12, wherein the field comprises a redundancy version field, and the one or more processors are configured to cause the UE to: receive an indication of a quantity of bits associated with the field, wherein the maximum quantity of bits is selected for the field based at least in part on the maximum quantity of scheduled shared channel communications and on the quantity of bits.
Aspect 14: The apparatus of aspect 13, wherein: the redundancy version field comprises a plurality of blocks of bits; each block of bits of the plurality of blocks of bits is associated with a respective shared channel communication and has a respective quantity of bits; and the indication of the quantity of bits comprises each respective quantity of bits for each shared channel communication of each cell.
Aspect 15: The apparatus of any of aspects 10 through 14, wherein the one or more processors are configured to cause the UE to: receive, via the downlink control information message, a second field applicable to the first shared channel communication, the second shared channel communication, and the third shared channel communication, wherein the second field comprises information associated with frequency domain resource allocation, a modulation and coding scheme, or both.
Aspect 16: An apparatus for wireless communication at a network entity, comprising: one or more memories; and one or more processors coupled with the one or more memories and configured to cause the network entity to: output a downlink control information message that schedules a plurality of downlink messages across a plurality of cells, wherein the plurality of downlink messages includes at least a first downlink message via a first cell, a second downlink message via a second cell, and a third downlink message via the first cell, and wherein a last symbol of the third downlink message occurs after the first downlink message and the second downlink message in a time domain; and obtain a first feedback message associated with the first downlink message in accordance with an offset from the last symbol of the third downlink message based at least in part on reception of the downlink control information message that scheduled the plurality of downlink messages across the plurality of cells that includes the first cell and the second cell and with at least one cell having a plurality of scheduled downlink messages, wherein the first feedback message includes one or more bits in accordance with a sub-codebook of a plurality of sub-codebooks that is associated with the plurality of downlink messages across the plurality of cells, wherein the one or more bits are ordered by starting reception time among downlink messages transmitted via the first cell, first, and by cell index of the plurality of cells, second.
Aspect 17: The network entity of aspect 16, wherein the first downlink message is associated with a first processing time that terminates prior to the offset and the second downlink message is associated with a second processing time that terminates after the offset, and the one or more processors are configured to cause the network entity to: obtain, via the first feedback message, one or more acknowledgment (ACK) bits based at least in part on the first processing time; and obtain, via a second feedback message associated with the second downlink message, one or more not-acknowledgment (NACK) bits based at least in part on the second processing time.
Aspect 18: The network entity of any of aspects 16 through 17, wherein at least one downlink message of the plurality of downlink messages is associated with a processing time that terminates after the offset, and the one or more processors are configured to cause the network entity to: obtain, via at least the first feedback message, one or more not acknowledgment (NACK) bits based at least in part on the processing time of the at least one downlink message.
Aspect 19: The network entity of any of aspects 16 through 18, wherein the one or more processors are configured to cause the network entity to: output a second downlink control information message that schedules a second plurality of downlink messages that includes at least a fourth downlink message via the first cell, a fifth downlink message via the second cell, and a sixth downlink message via the first cell, wherein at least one downlink message of the second plurality of downlink messages is associated with a processing time that terminates after a second offset from a last symbol of the second plurality of downlink messages; and refrain from monitoring for a feedback message associated with the fourth downlink message, the fifth downlink message, and the sixth downlink message based at least in part on the processing time of the at least one downlink message.
Aspect 20: The network entity of any of aspects 16 through 19, wherein: the one or more bits of the first feedback message are obtained in accordance with a set of time domain resource allocations, and the set of time domain resource allocations includes one or more entries that are associated with each downlink message of the plurality of downlink messages across the plurality of cells.
Aspect 21: An apparatus for wireless communication at a UE, comprising: one or more memories; and one or more processors coupled with the one or more memories and configured to cause the UE to: receive a downlink control information message that schedules at least a first shared channel communication via a first cell, a second shared channel communication via a second cell, and a third shared channel communication via the first cell, wherein the downlink control information message includes a field that is applicable to the first shared channel communication, the second shared channel communication, and the third shared channel communication, and wherein the field has a maximum quantity of bits that is based at least in part on a maximum quantity of scheduled shared channel communications associated with at least the first cell and the second cell; communicate the first shared channel communication via the first cell in accordance with one or more first bits of the field associated with the first cell; communicate the second shared channel communication via the second cell in accordance with one or more second bits of the field associated with the second cell;
and communicate the third shared channel communication via the first cell in accordance with one or more third bits of the field associated with the first cell.
Aspect 22: The apparatus of aspect 21, wherein the field comprises a new data indicator field, and the maximum quantity of bits is selected for the new data indicator field based at least in part on the maximum quantity of scheduled shared channel communications.
Aspect 23: The apparatus of any of aspects 21 through 22, wherein the one or more processors are configured to cause the UE to: receive an indication of a quantity of cells that have scheduled shared channel communications with the UE, wherein an association between each bit of the field and a respective shared channel communication is based at least in part on the quantity of cells.
Aspect 24: The apparatus of any of aspects 21 through 23, wherein the field comprises a redundancy version field, wherein the one or more processors are configured to cause the UE to: receive an indication of a quantity of bits associated with the field, wherein the maximum quantity of bits is selected for the field based at least in part on the maximum quantity of scheduled shared channel communications and on the quantity of bits.
Aspect 25: The apparatus of aspect 24, wherein the redundancy version field comprises a plurality of blocks of bits, and each block of bits of the plurality of blocks of bits is associated with a respective shared channel communication and has a respective quantity of bits corresponding to the quantity of bits.
Aspect 26: The apparatus of any of aspects 24 through 25, wherein the redundancy version field comprises a plurality of blocks of bits, each block of bits of the plurality of blocks of bits is associated with a respective shared channel communication and has a respective quantity of bits, and the indication of the quantity of bits comprises each respective quantity of bits for each shared channel communication of each cell.
Aspect 27: The apparatus of any of aspects 21 through 26, wherein the one or more processors are configured to cause the UE to: receive, via the downlink control information message, a second field applicable to the first shared channel communication, the second shared channel communication, and the third shared channel communication, wherein the second field comprises information associated with frequency domain resource allocation, a modulation and coding scheme, or both.
Aspect 28: The apparatus of aspect 27, wherein the second field indicates a first frequency domain resource allocation, a first modulation and coding scheme, or both for the first shared channel communication and the third shared channel communication, and the second field indicates a second frequency domain resource allocation, a second modulation and coding scheme, or both for the second shared channel communication.
Aspect 29: The apparatus of any of aspects 21 through 28, wherein the one or more processors are configured to cause the UE to: receive, via the downlink control information message, a second field applicable to the first shared channel communication, the second shared channel communication, and the third shared channel communication, wherein the second field comprises information that indicates a first hybrid automatic repeat request process number for the first shared channel communication and the third shared channel communication, and indicates a second hybrid automatic repeat request process number for the second shared channel communication.
Aspect 30: An apparatus for wireless communication at a UE, comprising: one or more memories; and one or more processors coupled with the one or more memories and configured to cause the UE to: receive a downlink control information message that schedules a plurality of downlink messages, wherein the plurality of downlink messages includes at least a first downlink message via a first cell, a second downlink message via a second cell, and a third downlink message via the first cell, and wherein a last symbol of the third downlink message occurs after the first downlink message and the second downlink message in a time domain; and transmit a first feedback message associated with the first downlink message in accordance with an offset from the last symbol of the third downlink message based at least in part on reception of the downlink control information message that scheduled the plurality of downlink messages across a plurality of cells that includes the first cell and the second cell and with at least one cell having a plurality of scheduled downlink messages.
Aspect 31: The apparatus of aspect 30, wherein the one or more processors are configured to cause the UE to: generate one or more bits for the first feedback message in accordance with a set of time domain resource allocations, wherein the set of time domain resource allocations includes one or more entries that are associated with each downlink message of the plurality of downlink messages across the plurality of cells, and wherein transmitting the first feedback message is based at least in part on the generation of the one or more bits.
Aspect 32: The apparatus of any of aspects 30 through 31, wherein the one or more processors are configured to cause the UE to: generate one or more bits for the first feedback message in accordance with a sub-codebook of a plurality of sub-codebooks that is associated with the plurality of downlink messages across the plurality of cells, wherein transmitting the first feedback message is based at least in part on the generation of the one or more bits.
Aspect 33: The apparatus of any of aspects 30 through 32, wherein the one or more processors are configured to cause the UE to: receive a second downlink control information message during a same monitoring occasion as the downlink control information message, wherein the second downlink control information message schedules a second plurality of downlink messages that includes at least a fourth downlink message via the first cell, the second cell, or a third cell; and transmit a second feedback message associated with the fourth downlink message, wherein the first feedback message is transmitted prior to the second feedback message based at least in part on the downlink control information message and the second downlink control information message.
Aspect 34: The apparatus of aspect 33, wherein the first feedback message is transmitted prior to the second feedback message based at least in part on an order of the downlink control information message and the second downlink control information message, and the order is based at least in part on an aggregation level, a search space index, a control resource set index, a control channel element index, or any combination thereof.
Aspect 35: The apparatus of aspect 33, wherein the first feedback message is transmitted prior to the second feedback message based at least in part on a first reception start time of the first downlink message occurring prior to a second reception start time of the fourth downlink message.
Aspect 36: The apparatus of any of aspects 30 through 35, wherein the one or more processors are configured to cause the UE to: generate one or more bundled bits for the first feedback message, wherein the one or more bundled bits comprise feedback information associated with a first transport block of the first downlink message and at least a second transport block of the first downlink message, or associated with the first downlink message and at least a fourth downlink message different than the first downlink message, or both.
Aspect 37: The apparatus of any of aspects 30 through 36, wherein the plurality of downlink messages includes a fourth downlink message that has a last symbol that occurs at a same time as the last symbol of the third downlink message in the time domain, the third downlink message is associated with a first processing time that is greater than a second processing time associated with the fourth downlink message, and the first feedback message is transmitted based at least in part on the first processing time that is greater than the second processing time.
Aspect 38: The apparatus of any of aspects 30 through 37, wherein the first downlink message is associated with a first processing time that terminates prior to the offset and the second downlink message is associated with a second processing time that terminates after the offset, wherein the one or more processors are configured to cause the UE to: transmit, via the first feedback message, one or more ACK bits based at least in part on the first processing time; and transmit, via a second feedback message associated with the second downlink message, one or more NACK bits based at least in part on the second processing time.
Aspect 39: The apparatus of any of aspects 30 through 37, wherein at least one downlink message of the plurality of downlink messages is associated with a processing time that terminates after the offset, wherein the one or more processors are configured to cause the UE to: transmit, via at least the first feedback message, one or more NACK bits based at least in part on the processing time of the at least one downlink message.
Aspect 40: The apparatus of any of aspects 30 through 37, wherein the one or more processors are configured to cause the UE to: receive a second downlink control information message that schedules a second plurality of downlink messages that includes at least a fourth downlink message via the first cell, a fifth downlink message via the second cell, and a sixth downlink message via the first cell, wherein at least one downlink message of the second plurality of downlink messages is associated with a processing time that terminates after a second offset from a last symbol of the second plurality of downlink messages; and refrain from transmitting a feedback message associated with the fourth downlink message, the fifth downlink message, and the sixth downlink message based at least in part on the processing time of the at least one downlink message.
Aspect 41: A apparatus for wireless communications at a network entity, comprising: one or more memories; and one or more processors coupled with the one or more memories and configured to cause the network entity to: output a downlink control information message that schedules at least a first shared channel communication via a first cell, a second shared channel communication via a second cell, and a third shared channel communication via the first cell, wherein the downlink control information message includes a field that is applicable to the first shared channel communication, the second shared channel communication, and the third shared channel communication, and wherein the field has a maximum quantity of bits that is based at least in part on a maximum quantity of scheduled shared channel communications associated with at least the first cell and the second cell; communicate the first shared channel communication via the first cell in accordance with one or more first bits of the field associated with the first cell; communicate the second shared channel communication via the second cell in accordance with one or more second bits of the field associated with the second cell; and communicate the third shared channel communication via the first cell in accordance with one or more third bits of the field associated with the first cell.
Aspect 42: The apparatus of aspect 41, wherein the field comprises a new data indicator field, and the maximum quantity of bits is selected for the new data indicator field based at least in part on the maximum quantity of scheduled shared channel communications.
Aspect 43: The apparatus of any of aspects 41 through 42, further comprising: outputting an indication of a quantity of cells that have scheduled shared channel communications, wherein an association between each bit of the field and a respective shared channel communication is based at least in part on the quantity of cells.
Aspect 44: The apparatus of any of aspects 41 through 43, wherein the field comprises a redundancy version field, wherein the one or more processors are configured to cause the network entity to: output an indication of a quantity of bits associated with the field, wherein the maximum quantity of bits is selected for the field based at least in part on the maximum quantity of scheduled shared channel communications and on the quantity of bits.
Aspect 45: The apparatus of aspect 44, wherein the redundancy version field comprises a plurality of blocks of bits, and each block of bits of the plurality of blocks of bits is associated with a respective shared channel communication and has a respective quantity of bits corresponding to the quantity of bits.
Aspect 46: The apparatus of any of aspects 44 through 45, wherein the redundancy version field comprises a plurality of blocks of bits, each block of bits of the plurality of blocks of bits is associated with a respective shared channel communication and has a respective quantity of bits, and the indication of the quantity of bits comprises each respective quantity of bits for each shared channel communication of each cell.
Aspect 47: The apparatus of any of aspects 41 through 46, wherein the one or more processors are configured to cause the network entity to: output, via the downlink control information message, a second field applicable to the first shared channel communication, the second shared channel communication, and the third shared channel communication, wherein the second field comprises information associated with frequency domain resource allocation, a modulation and coding scheme, or both.
Aspect 48: The apparatus of aspect 47, wherein the second field indicates a first frequency domain resource allocation, a first modulation and coding scheme, or both for the first shared channel communication and the third shared channel communication, and the second field indicates a second frequency domain resource allocation, a second modulation and coding scheme, or both for the second shared channel communication.
Aspect 49: The apparatus of any of aspects 41 through 48, wherein the one or more processors are configured to cause the network entity to: output, via the downlink control information message, a second field applicable to the first shared channel communication, the second shared channel communication, and the third shared channel communication, wherein the second field comprises information that indicates a first hybrid automatic repeat request process number for the first shared channel communication and the third shared channel communication, and indicates a second hybrid automatic repeat request process number for the second shared channel communication.
Aspect 50: An apparatus for wireless communications at a network entity, comprising one or more memories; and one or more processors coupled with the one or more memories and configured to cause the network entity to: outputting a downlink control information message that schedules a plurality of downlink messages, wherein the plurality of downlink messages includes at least a first downlink message via a first cell, a second downlink message via a second cell, and a third downlink message via the first cell, and wherein a last symbol of the third downlink message occurs after the first downlink message and the second downlink message in a time domain; and obtaining a first feedback message associated with the first downlink message in accordance with an offset from the last symbol of the third downlink message based at least in part on reception of the downlink control information message that scheduled the plurality of downlink messages across a plurality of cells that includes the first cell and the second cell and with at least one cell having a plurality of scheduled downlink messages.
Aspect 51: The apparatus of aspect 50, wherein one or more bits of the first feedback message are obtained in accordance with a set of time domain resource allocations, and the set of time domain resource allocations includes one or more entries that are associated with each downlink message of the plurality of downlink messages across the plurality of cells.
Aspect 52: The apparatus of any of aspects 50 through 51, wherein one or more bits of the first feedback message are obtained in accordance with a sub-codebook of a plurality of sub-codebooks that is associated with the plurality of downlink messages across the plurality of cells.
Aspect 53: The apparatus of any of aspects 50 through 52, wherein the one or more processors are configured to cause the network entity to: output a second downlink control information message during a same monitoring occasion as the downlink control information message, wherein the second downlink control information message schedules a second plurality of downlink messages that includes at least a fourth downlink message via the first cell, the second cell, or a third cell; and obtain a second feedback message associated with the fourth downlink message, wherein the first feedback message is obtained prior to the second feedback message based at least in part on the downlink control information message and the second downlink control information message.
Aspect 54: The apparatus of aspect 53, wherein the first feedback message is obtained prior to the second feedback message based at least in part on an order of the downlink control information message and the second downlink control information message, and the order is based at least in part on an aggregation level, a search space index, a control resource set index, a control channel element index, or any combination thereof.
Aspect 55: The apparatus of aspect 53, wherein the first feedback message is transmitted prior to the second feedback message based at least in part on a first reception start time of the first downlink message occurring prior to a second reception start time of the fourth downlink message.
Aspect 56: The apparatus of any of aspects 50 through 55, wherein the first feedback message includes one or more bundled bits that comprise feedback information associated with a first transport block of the first downlink message and at least a second transport block of the first downlink message, or associated with the first downlink message and at least a fourth downlink message different than the first downlink message, or both.
Aspect 57: The apparatus of any of aspects 50 through 56, wherein the plurality of downlink messages includes a fourth downlink message that has a last symbol that occurs at a same time as the last symbol of the third downlink message in the time domain, the third downlink message is associated with a first processing time that is greater than a second processing time associated with the fourth downlink message, and the first feedback message is obtained based at least in part on the first processing time that is greater than the second processing time.
Aspect 58: The apparatus of any of aspects 50 through 57, wherein the first downlink message is associated with a first processing time that terminates prior to the offset and the second downlink message is associated with a second processing time that terminates after the offset, wherein the one or more processors are configured to cause the network entity to: obtain, via the first feedback message, one or more ACK bits based at least in part on the first processing time; and obtain, via a second feedback message associated with the second downlink message, one or more NACK bits based at least in part on the second processing time.
Aspect 59: The apparatus of any of aspects 50 through 57, wherein at least one downlink message of the plurality of downlink messages is associated with a processing time that terminates after the offset, wherein the one or more processors are configured to cause the network entity to: obtain, via at least the first feedback message, one or more NACK bits based at least in part on the processing time of the at least one downlink message.
Aspect 60: The apparatus of any of aspects 50 through 57, wherein the one or more processors are configured to cause the network entity to: output a second downlink control information message that schedules a second plurality of downlink messages that includes at least a fourth downlink message via the first cell, a fifth downlink message via the second cell, and a sixth downlink message via the first cell, wherein at least one downlink message of the second plurality of downlink messages is associated with a processing time that terminates after a second offset from a last symbol of the second plurality of downlink messages; and refrain from obtain a feedback message associated with the fourth downlink message, the fifth downlink message, and the sixth downlink message based at least in part on the processing time of the at least one downlink message.
Aspect 61: A method for wireless communications at a UE, comprising: receiving a downlink control information message that schedules at least a first shared channel communication via a first cell, a second shared channel communication via a second cell, and a third shared channel communication via the first cell, wherein the downlink control information message includes a field that is applicable to the first shared channel communication, the second shared channel communication, and the third shared channel communication, and wherein the field has a maximum quantity of bits that is based at least in part on a maximum quantity of scheduled shared channel communications associated with at least the first cell and the second cell; communicating the first shared channel communication via the first cell in accordance with one or more first bits of the field associated with the first cell; communicating the second shared channel communication via the second cell in accordance with one or more second bits of the field associated with the second cell; and communicating the third shared channel communication via the first cell in accordance with one or more third bits of the field associated with the first cell.
Aspect 62: The method of aspect 61, wherein the field comprises a new data indicator field, and the maximum quantity of bits is selected for the new data indicator field based at least in part on the maximum quantity of scheduled shared channel communications.
Aspect 63: The method of any of aspects 61 through 62, further comprising: receiving an indication of a quantity of cells that have scheduled shared channel communications with the UE, wherein an association between each bit of the field and a respective shared channel communication is based at least in part on the quantity of cells.
Aspect 64: The method of any of aspects 61 through 63, wherein the field comprises a redundancy version field, the method further comprising: receiving an indication of a quantity of bits associated with the field, wherein the maximum quantity of bits is selected for the field based at least in part on the maximum quantity of scheduled shared channel communications and on the quantity of bits.
Aspect 65: The method of aspect 64, wherein the redundancy version field comprises a plurality of blocks of bits, and each block of bits of the plurality of blocks of bits is associated with a respective shared channel communication and has a respective quantity of bits corresponding to the quantity of bits.
Aspect 66: The method of any of aspects 64 through 65, wherein the redundancy version field comprises a plurality of blocks of bits, each block of bits of the plurality of blocks of bits is associated with a respective shared channel communication and has a respective quantity of bits, and the indication of the quantity of bits comprises each respective quantity of bits for each shared channel communication of each cell.
Aspect 67: The method of any of aspects 61 through 66, further comprising: receiving, via the downlink control information message, a second field applicable to the first shared channel communication, the second shared channel communication, and the third shared channel communication, wherein the second field comprises information associated with frequency domain resource allocation, a modulation and coding scheme, or both.
Aspect 68: The method of aspect 67, wherein the second field indicates a first frequency domain resource allocation, a first modulation and coding scheme, or both for the first shared channel communication and the third shared channel communication, and the second field indicates a second frequency domain resource allocation, a second modulation and coding scheme, or both for the second shared channel communication.
Aspect 69: The method of any of aspects 61 through 68, further comprising: receiving, via the downlink control information message, a second field applicable to the first shared channel communication, the second shared channel communication, and the third shared channel communication, wherein the second field comprises information that indicates a first hybrid automatic repeat request process number for the first shared channel communication and the third shared channel communication, and indicates a second hybrid automatic repeat request process number for the second shared channel communication.
Aspect 70: A method for wireless communications at a UE, comprising: receiving a downlink control information message that schedules a plurality of downlink messages, wherein the plurality of downlink messages includes at least a first downlink message via a first cell, a second downlink message via a second cell, and a third downlink message via the first cell, and wherein a last symbol of the third downlink message occurs after the first downlink message and the second downlink message in a time domain; and transmitting a first feedback message associated with the first downlink message in accordance with an offset from the last symbol of the third downlink message based at least in part on reception of the downlink control information message that scheduled the plurality of downlink messages across a plurality of cells that includes the first cell and the second cell and with at least one cell having a plurality of scheduled downlink messages.
Aspect 71: The method of aspect 70, further comprising: generating one or more bits for the first feedback message in accordance with a set of time domain resource allocations, wherein the set of time domain resource allocations includes one or more entries that are associated with each downlink message of the plurality of downlink messages across the plurality of cells, and wherein transmitting the first feedback message is based at least in part on the generation of the one or more bits.
Aspect 72: The method of any of aspects 70 through 71, further comprising: generating one or more bits for the first feedback message in accordance with a sub-codebook of a plurality of sub-codebooks that is associated with the plurality of downlink messages across the plurality of cells, wherein transmitting the first feedback message is based at least in part on the generation of the one or more bits.
Aspect 73: The method of any of aspects 70 through 72, further comprising: receiving a second downlink control information message during a same monitoring occasion as the downlink control information message, wherein the second downlink control information message schedules a second plurality of downlink messages that includes at least a fourth downlink message via the first cell, the second cell, or a third cell; and transmitting a second feedback message associated with the fourth downlink message, wherein the first feedback message is transmitted prior to the second feedback message based at least in part on the downlink control information message and the second downlink control information message.
Aspect 74: The method of aspect 73, wherein the first feedback message is transmitted prior to the second feedback message based at least in part on an order of the downlink control information message and the second downlink control information message, and the order is based at least in part on an aggregation level, a search space index, a control resource set index, a control channel element index, or any combination thereof.
Aspect 75: The method of aspect 73, wherein the first feedback message is transmitted prior to the second feedback message based at least in part on a first reception start time of the first downlink message occurring prior to a second reception start time of the fourth downlink message.
Aspect 76: The method of any of aspects 70 through 75, further comprising: generating one or more bundled bits for the first feedback message, wherein the one or more bundled bits comprise feedback information associated with a first transport block of the first downlink message and at least a second transport block of the first downlink message, or associated with the first downlink message and at least a fourth downlink message different than the first downlink message, or both.
Aspect 77: The method of any of aspects 70 through 76, wherein the plurality of downlink messages includes a fourth downlink message that has a last symbol that occurs at a same time as the last symbol of the third downlink message in the time domain, the third downlink message is associated with a first processing time that is greater than a second processing time associated with the fourth downlink message, and the first feedback message is transmitted based at least in part on the first processing time that is greater than the second processing time.
Aspect 78: The method of any of aspects 70 through 77, wherein the first downlink message is associated with a first processing time that terminates prior to the offset and the second downlink message is associated with a second processing time that terminates after the offset, the method further comprising: transmitting, via the first feedback message, one or more ACK bits based at least in part on the first processing time; and transmitting, via a second feedback message associated with the second downlink message, one or more NACK bits based at least in part on the second processing time.
Aspect 79: The method of any of aspects 70 through 77, wherein at least one downlink message of the plurality of downlink messages is associated with a processing time that terminates after the offset, the method further comprising: transmitting, via at least the first feedback message, one or more NACK bits based at least in part on the processing time of the at least one downlink message.
Aspect 80: The method of any of aspects 70 through 77, further comprising: receiving a second downlink control information message that schedules a second plurality of downlink messages that includes at least a fourth downlink message via the first cell, a fifth downlink message via the second cell, and a sixth downlink message via the first cell, wherein at least one downlink message of the second plurality of downlink messages is associated with a processing time that terminates after a second offset from a last symbol of the second plurality of downlink messages; and refraining from transmitting a feedback message associated with the fourth downlink message, the fifth downlink message, and the sixth downlink message based at least in part on the processing time of the at least one downlink message.
Aspect 81: A method for wireless communications at a network entity, comprising: outputting a downlink control information message that schedules at least a first shared channel communication via a first cell, a second shared channel communication via a second cell, and a third shared channel communication via the first cell, wherein the downlink control information message includes a field that is applicable to the first shared channel communication, the second shared channel communication, and the third shared channel communication, and wherein the field has a maximum quantity of bits that is based at least in part on a maximum quantity of scheduled shared channel communications associated with at least the first cell and the second cell; communicating the first shared channel communication via the first cell in accordance with one or more first bits of the field associated with the first cell; communicating the second shared channel communication via the second cell in accordance with one or more second bits of the field associated with the second cell; and communicating the third shared channel communication via the first cell in accordance with one or more third bits of the field associated with the first cell.
Aspect 82: The method of aspect 81, wherein the field comprises a new data indicator field, and the maximum quantity of bits is selected for the new data indicator field based at least in part on the maximum quantity of scheduled shared channel communications.
Aspect 83: The method of any of aspects 81 through 82, further comprising: outputting an indication of a quantity of cells that have scheduled shared channel communications, wherein an association between each bit of the field and a respective shared channel communication is based at least in part on the quantity of cells.
Aspect 84: The method of any of aspects 81 through 83, wherein the field comprises a redundancy version field, the method further comprising: outputting an indication of a quantity of bits associated with the field, wherein the maximum quantity of bits is selected for the field based at least in part on the maximum quantity of scheduled shared channel communications and on the quantity of bits.
Aspect 85: The method of aspect 84, wherein the redundancy version field comprises a plurality of blocks of bits, and each block of bits of the plurality of blocks of bits is associated with a respective shared channel communication and has a respective quantity of bits corresponding to the quantity of bits.
Aspect 86: The method of any of aspects 84 through 85, wherein the redundancy version field comprises a plurality of blocks of bits, each block of bits of the plurality of blocks of bits is associated with a respective shared channel communication and has a respective quantity of bits, and the indication of the quantity of bits comprises each respective quantity of bits for each shared channel communication of each cell.
Aspect 87: The method of any of aspects 81 through 86, further comprising: outputting, via the downlink control information message, a second field applicable to the first shared channel communication, the second shared channel communication, and the third shared channel communication, wherein the second field comprises information associated with frequency domain resource allocation, a modulation and coding scheme, or both.
Aspect 88: The method of aspect 87, wherein the second field indicates a first frequency domain resource allocation, a first modulation and coding scheme, or both for the first shared channel communication and the third shared channel communication, and the second field indicates a second frequency domain resource allocation, a second modulation and coding scheme, or both for the second shared channel communication.
Aspect 89: The method of any of aspects 81 through 88, further comprising: outputting, via the downlink control information message, a second field applicable to the first shared channel communication, the second shared channel communication, and the third shared channel communication, wherein the second field comprises information that indicates a first hybrid automatic repeat request process number for the first shared channel communication and the third shared channel communication, and indicates a second hybrid automatic repeat request process number for the second shared channel communication.
Aspect 90: A method for wireless communications at a network entity, comprising: outputting a downlink control information message that schedules a plurality of downlink messages, wherein the plurality of downlink messages includes at least a first downlink message via a first cell, a second downlink message via a second cell, and a third downlink message via the first cell, and wherein a last symbol of the third downlink message occurs after the first downlink message and the second downlink message in a time domain; and obtaining a first feedback message associated with the first downlink message in accordance with an offset from the last symbol of the third downlink message based at least in part on reception of the downlink control information message that scheduled the plurality of downlink messages across a plurality of cells that includes the first cell and the second cell and with at least one cell having a plurality of scheduled downlink messages.
Aspect 91: The method of aspect 90, wherein one or more bits of the first feedback message are obtained in accordance with a set of time domain resource allocations, and the set of time domain resource allocations includes one or more entries that are associated with each downlink message of the plurality of downlink messages across the plurality of cells.
Aspect 92: The method of any of aspects 90 through 91, wherein one or more bits of the first feedback message are obtained in accordance with a sub-codebook of a plurality of sub-codebooks that is associated with the plurality of downlink messages across the plurality of cells.
Aspect 93: The method of any of aspects 90 through 92, further comprising: outputting a second downlink control information message during a same monitoring occasion as the downlink control information message, wherein the second downlink control information message schedules a second plurality of downlink messages that includes at least a fourth downlink message via the first cell, the second cell, or a third cell; and obtaining a second feedback message associated with the fourth downlink message, wherein the first feedback message is obtained prior to the second feedback message based at least in part on the downlink control information message and the second downlink control information message.
Aspect 94: The method of aspect 93, wherein the first feedback message is obtained prior to the second feedback message based at least in part on an order of the downlink control information message and the second downlink control information message, and the order is based at least in part on an aggregation level, a search space index, a control resource set index, a control channel element index, or any combination thereof.
Aspect 95: The method of aspect 93, wherein the first feedback message is transmitted prior to the second feedback message based at least in part on a first reception start time of the first downlink message occurring prior to a second reception start time of the fourth downlink message.
Aspect 96: The method of any of aspects 90 through 95, wherein the first feedback message includes one or more bundled bits that comprise feedback information associated with a first transport block of the first downlink message and at least a second transport block of the first downlink message, or associated with the first downlink message and at least a fourth downlink message different than the first downlink message, or both.
Aspect 97: The method of any of aspects 90 through 96, wherein the plurality of downlink messages includes a fourth downlink message that has a last symbol that occurs at a same time as the last symbol of the third downlink message in the time domain, the third downlink message is associated with a first processing time that is greater than a second processing time associated with the fourth downlink message, and the first feedback message is obtained based at least in part on the first processing time that is greater than the second processing time.
Aspect 98: The method of any of aspects 90 through 97, wherein the first downlink message is associated with a first processing time that terminates prior to the offset and the second downlink message is associated with a second processing time that terminates after the offset, the method further comprising: obtaining, via the first feedback message, one or more ACK bits based at least in part on the first processing time; and obtaining, via a second feedback message associated with the second downlink message, one or more NACK bits based at least in part on the second processing time.
Aspect 99: The method of any of aspects 90 through 97, wherein at least one downlink message of the plurality of downlink messages is associated with a processing time that terminates after the offset, the method further comprising: obtaining, via at least the first feedback message, one or more NACK bits based at least in part on the processing time of the at least one downlink message.
Aspect 100: The method of any of aspects 90 through 97, further comprising: outputting a second downlink control information message that schedules a second plurality of downlink messages that includes at least a fourth downlink message via the first cell, a fifth downlink message via the second cell, and a sixth downlink message via the first cell, wherein at least one downlink message of the second plurality of downlink messages is associated with a processing time that terminates after a second offset from a last symbol of the second plurality of downlink messages; and refraining from obtaining a feedback message associated with the fourth downlink message, the fifth downlink message, and the sixth downlink message based at least in part on the processing time of the at least one downlink message.
Aspect 101: An apparatus for wireless communication at a UE, comprising one or more memories, and one or more processors coupled with the one or more memories and configured to cause the UE to perform a method of any of aspects 61 through 69.
Aspect 102: A UE for wireless communications, comprising at least one means for performing a method of any of aspects 61 through 69.
Aspect 103: A non-transitory computer-readable medium storing code for wireless communications, the code comprising instructions executable by one or more processors to perform a method of any of aspects 61 through 69.
Aspect 104: An apparatus for wireless communication at a UE, comprising one or more memories, and one or more processors coupled with the one or more memories and configured to cause the UE to perform a method of any of aspects 70 through 80.
Aspect 105: A UE for wireless communications, comprising at least one means for performing a method of any of aspects 70 through 80.
Aspect 106: A non-transitory computer-readable medium storing code for wireless communications, the code comprising instructions executable by one or more processors to perform a method of any of aspects 70 through 80.
Aspect 107: An apparatus for wireless communication at a network entity, comprising one or more memories, and one or more processors coupled with the one or more memories and configured to cause the network entity to perform a method of any of aspects 81 through 89.
Aspect 108: A network entity for wireless communications, comprising at least one means for performing a method of any of aspects 81 through 89.
Aspect 109: A non-transitory computer-readable medium storing code for wireless communications, the code comprising instructions executable by one or more processors to perform a method of any of aspects 81 through 89.
Aspect 110: An apparatus for wireless communication at a network entity, comprising one or more memories, and one or more processors coupled with the one or more memories and configured to cause the network entity to perform a method of any of aspects 90 through 100.
Aspect 111: A network entity for wireless communications, comprising at least one means for performing a method of any of aspects 90 through 100.
Aspect 112: A non-transitory computer-readable medium storing code for wireless communications, the code comprising instructions executable by one or more processors to perform a method of any of aspects 90 through 100.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive a downlink control information message that schedules a plurality of downlink messages across a plurality of cells, wherein the plurality of downlink messages includes at least a first downlink message via a first cell, a second downlink message via a second cell, and a third downlink message via the first cell, and wherein a last symbol of the third downlink message occurs after the first downlink message and the second downlink message in a time domain;
generate one or more bits for a first feedback message in accordance with a sub-codebook of a plurality of sub-codebooks that is associated with the plurality of downlink messages across the plurality of cells, wherein the one or more bits are ordered by starting reception time among downlink messages received via the first cell, first, and by cell index of the plurality of cells, second; and
transmit the first feedback message associated with the first downlink message in accordance with an offset from the last symbol of the third downlink message based at least in part on reception of the downlink control information message that scheduled the plurality of downlink messages across the plurality of cells that includes the first cell and the second cell and with at least one cell having a plurality of scheduled downlink messages, wherein the transmission of the first feedback message is based at least in part on the generation of the one or more bits.

2. The apparatus of claim 1, wherein the first downlink message is associated with a first processing time that terminates prior to the offset and the second downlink message is associated with a second processing time that terminates after the offset, and the one or more processors are configured to cause the UE to:
transmit, via the first feedback message, one or more acknowledgment (ACK) bits based at least in part on the first processing time; and
transmit, via a second feedback message associated with the second downlink message, one or more not-acknowledgment (NACK) bits based at least in part on the second processing time.

3. The apparatus of claim 1, wherein at least one downlink message of the plurality of downlink messages is associated with a processing time that terminates after the offset, and the one or more processors are configured to cause the UE to:
transmit, via at least the first feedback message, one or more not acknowledgment (NACK) bits based at least in part on the processing time of the at least one downlink message.

4. The apparatus of claim 1, wherein the one or more processors are configured to cause the UE to:
receive a second downlink control information message that schedules a second plurality of downlink messages that includes at least a fourth downlink message via the first cell, a fifth downlink message via the second cell, and a sixth downlink message via the first cell, wherein at least one downlink message of the second plurality of downlink messages is associated with a processing time that terminates after a second offset from a last symbol of the second plurality of downlink messages; and
refrain from transmission of a feedback message associated with the fourth downlink message, the fifth downlink message, and the sixth downlink message based at least in part on the processing time of the at least one downlink message.

5. The apparatus of claim 1, wherein the one or more processors are configured to cause the UE to:
generate one or more bits for the first feedback message in accordance with a set of time domain resource allocations, wherein the set of time domain resource allocations includes one or more entries that are associated with each downlink message of the plurality of downlink messages across the plurality of cells, and wherein the transmission of the first feedback message is based at least in part on the generation of the one or more bits.

6. The apparatus of claim 1, wherein the one or more processors are configured to cause the UE to:
receive, via an antenna array of the UE, a second downlink control information message within a same monitoring occasion as the downlink control information message, wherein the second downlink control information message schedules a second plurality of downlink messages that includes at least a fourth downlink message via the first cell, the second cell, or a third cell; and
transmit a second feedback message associated with the fourth downlink message, wherein the first feedback message is transmitted prior to the second feedback message based at least in part on the downlink control information message and the second downlink control information message.

7. The apparatus of claim 6, wherein:
the first feedback message is transmitted prior to the second feedback message based at least in part on an order of the downlink control information message and the second downlink control information message; and
the order is based at least in part on an aggregation level, a search space index, a control resource set index, a control channel element index, or any combination thereof.

8. The apparatus of claim 6, wherein the first feedback message is transmitted prior to the second feedback message based at least in part on a first reception start time of the first downlink message that occurs prior to a second reception start time of the fourth downlink message.

9. The apparatus of claim 1, wherein:
the plurality of downlink messages includes a fourth downlink message that has a last symbol that occurs at a same time as the last symbol of the third downlink message in the time domain,
the third downlink message is associated with a first processing time that is greater than a second processing time associated with the fourth downlink message, and
the first feedback message is transmitted based at least in part on the first processing time that is greater than the second processing time.

10. An apparatus for wireless communication at a user equipment (UE), comprising:
one or more memories; and
one or more processors coupled with the one or more memories and configured to cause the UE to:
receive a downlink control information message that schedules at least a first shared channel communication via a first cell, a second shared channel communication via a second cell, and a third shared channel communication via the first cell, wherein the downlink control information message includes a field that is applicable to the first shared channel communication, the second shared channel communication, and the third shared channel communication, and wherein the field has a maximum quantity of bits that is based at least in part on a maximum quantity of scheduled shared channel communications associated with at least the first cell and the second cell;
communicate the first shared channel communication via the first cell in accordance with one or more first bits of the field associated with the first cell;
communicate the second shared channel communication via the second cell in accordance with one or more second bits of the field associated with the second cell; and
communicate the third shared channel communication via the first cell in accordance with one or more third bits of the field associated with the first cell.

11. The apparatus of claim 10, wherein:
the field comprises a new data indicator field; and
the maximum quantity of bits is selected for the new data indicator field based at least in part on the maximum quantity of scheduled shared channel communications.

12. The apparatus of claim 10, wherein the one or more processors are configured to cause the UE to:
receive, via an antenna array of the UE, an indication of a quantity of cells that have scheduled shared channel communications with the UE, wherein an association between each bit of the field and a respective shared channel communication is based at least in part on the quantity of cells.

13. The apparatus of claim 10, wherein the field comprises a redundancy version field, and the one or more processors are configured to cause the UE to:
receive an indication of a quantity of bits associated with the field, wherein the maximum quantity of bits is selected for the field based at least in part on the maximum quantity of scheduled shared channel communications and on the quantity of bits.

14. The apparatus of claim 13, wherein:
the redundancy version field comprises a plurality of blocks of bits;
each block of bits of the plurality of blocks of bits is associated with a respective shared channel communication and has a respective quantity of bits; and
the indication of the quantity of bits comprises each respective quantity of bits for each shared channel communication of each cell.

15. The apparatus of claim 10, wherein the one or more processors are configured to cause the UE to:
receive, via the downlink control information message, a second field applicable to the first shared channel communication, the second shared channel communication, and the third shared channel communication, wherein the second field comprises information associated with frequency domain resource allocation, a modulation and coding scheme, or both.

16. An apparatus for wireless communication at a network entity, comprising:
one or more memories; and
one or more processors coupled with the one or more memories and configured to cause the network entity to:
output a downlink control information message that schedules a plurality of downlink messages across a plurality of cells, wherein the plurality of downlink messages includes at least a first downlink message via a first cell, a second downlink message via a second cell, and a third downlink message via the first cell, and wherein a last symbol of the third downlink message occurs after the first downlink message and the second downlink message in a time domain; and
obtain a first feedback message associated with the first downlink message in accordance with an offset from the last symbol of the third downlink message based at least in part on reception of the downlink control information message that scheduled the plurality of downlink messages across the plurality of cells that includes the first cell and the second cell and with at least one cell having a plurality of scheduled downlink messages, wherein the first feedback message includes one or more bits in accordance with a sub-codebook of a plurality of sub-codebooks that is associated with the plurality of downlink messages across the plurality of cells, wherein the one or more bits are ordered by starting reception time among downlink messages transmitted via the first cell, first, and by cell index of the plurality of cells, second.

17. The apparatus of claim 16, wherein the first downlink message is associated with a first processing time that terminates prior to the offset and the second downlink message is associated with a second processing time that terminates after the offset, and the one or more processors are configured to cause the network entity to:
obtain, via the first feedback message, one or more acknowledgment (ACK) bits based at least in part on the first processing time; and
obtain, via a second feedback message associated with the second downlink message, one or more not-acknowledgment (NACK) bits based at least in part on the second processing time.

18. The apparatus of claim 16, wherein at least one downlink message of the plurality of downlink messages is associated with a processing time that terminates after the offset, and the one or more processors are configured to cause the network entity to:
obtain, via at least the first feedback message, one or more not acknowledgment (NACK) bits based at least in part on the processing time of the at least one downlink message.

19. The apparatus of claim 16, wherein the one or more processors are configured to cause the network entity to:
output a second downlink control information message that schedules a second plurality of downlink messages that includes at least a fourth downlink message via the first cell, a fifth downlink message via the second cell, and a sixth downlink message via the first cell, wherein at least one downlink message of the second plurality of downlink messages is associated with a processing time that terminates after a second offset from a last symbol of the second plurality of downlink messages; and
refrain from monitoring for a feedback message associated with the fourth downlink message, the fifth downlink message, and the sixth downlink message based at least in part on the processing time of the at least one downlink message.

20. The apparatus of claim 16, wherein:
the one or more bits of the first feedback message are obtained in accordance with a set of time domain resource allocations, and
the set of time domain resource allocations includes one or more entries that are associated with each downlink message of the plurality of downlink messages across the plurality of cells.
